(19) United States
(12) Patent Application Publication
(10) Pub. No.: US 2011/0012560 A1
(43) Pub. Date: Jan. 20, 2011

(54) BATTERY PACK

(76) Inventor: Kazuyuki Sakakibara, Okazaki-shi (JP)

Correspondence Address: SCHWEGMAN, LUNDBERG & WOESSNER, P.A., P.O. BOX 2938, MINNEAPOLIS, MN, 55402, US

(21) Appl. No.: 12/888,877

(22) Filed: Sep. 23, 2010

Related U.S. Application Data
(63) Continuation-in-part of application No. PCT/JP2008/072736, filed on Dec. 15, 2008.

(30) Foreign Application Priority Data
Mar. 28, 2008 (JP) 2008-087049

(51) Int. Cl. H02J 7/00

(52) U.S. Cl. 320/118

(57) ABSTRACT

A battery pack is disclosed, including: a battery cell group of serially interconnected battery cells; discharge control circuitry for the battery cell group; and a discharge output terminal through which a discharge output of the battery cell group is supplied to an externally coupled electric device. The battery cell group cooperates with an input/output terminal electrically connected with the battery cell group to constitute one of battery modules which are serially connected with one another to constitute a battery module group. The battery pack further includes: a first detector detecting at least one of a voltage, a temperature and a current; and a first selector configured to select one of an enabling mode for the input/output terminal and a disabling mode. The discharge control circuitry transmits to the first selector a first signal indicating that output of a voltage to the discharge output terminal is disabled, when the discharge control circuitry attempts to disable the output of a voltage to the discharge output terminal, based on a detection result of the first detector. The first selector, based on the first signal received from the discharge control circuitry, enters the disabling mode.

### RELATED APPLICATIONS

This application is a continuation-in-part filing of International Patent Application No. PCT/JP2008/072736, filed Dec. 15, 2008 and published Oct. 1, 2009 as WO 2009/118963, which claims the priority benefit of Japanese Serial No. 2008-087049, filed Mar. 28, 2008, the contents of which applications and publication are incorporated herein by reference in their entirety.

### BACKGROUND OF THE INVENTION

1. Field of the Invention

The present invention relates to battery packs which are constructed with rechargeable batteries such as Li-ion batteries.

2. Description of the Related Art

Conventionally, a cordless power tool (see Japanese Patent Application Publication No. 2002-254355, for example) operates, such that a battery pack is charged via a charger with electricity which is supplied from a commercial power source, and such that a DC motor is driven using the battery pack as a power source. Alternatively, an AC power tool operates, such that an electrical cord thereof is directly connected with the commercial power source, and such that an AC motor is driven with electricity which is supplied from the commercial power source.

In recent years, technologies such as battery technologies or charge control process technologies have advanced to provide improvements in performance of battery packs for use in cordless power tools. Notably, Li-ion battery packs are used by an increasing number of people, in which increased energy density of these battery packs makes it ease to achieve reduced weight, increased voltage, and increased capacity, relative to battery packs using NiCd batteries or NiMH batteries.

### BRIEF SUMMARY OF THE INVENTION

For conventional technologies, a 14.4V cordless power tool system combined with a 14.4V Li-ion battery pack, a 36V cordless power tool system combined with 36V Li-ion battery pack and an AC power tool will be described respectively below.

As major demands from users of cordless power tools, high workability and cost reduction are focused on.

Here, the “high workability” means: weight reduction of a battery pack for reduction in user's workload; an increase in power output of the cordless power tool to that of an AC power tool; extension of run time of the cordless power tool which starts after one full charge cycle of the battery pack; and potential operability of the cordless power tool as a corded power tool such as an AC power tool, for a need for continued run time longer than the above-described run time.

On the other hand, the “cost reduction” means: reduction in initial cost for both the battery pack and its charger; and reduction in running cost of a cordless power tool system by virtue of extended life time of the battery pack.

Conventional systems including 14.4V cordless power tool systems and 36V cordless power tool systems, however, can be improved, because these systems have been specialized to have a system design that can satisfy only part of the above-described user demands.

More specifically, for example, for the 14.4V cordless power tool system, the system design has been specialized to offer advantages, i.e., a reduction in weight of the battery pack to an extent to which the user can physically perceive it light-weighted, while being satisfied; a reduction in run time of the tool system which starts after one full charge cycle of the battery pack, to an extent to which the user can feel that, when working under light loaded conditions, the run time is adequate, with resulting satisfaction; and a reduction in initial cost of the cordless power tool system by constructing the battery pack and its charger to have a low capacity of electrical power, relative to that of the 36V cordless power tool. For the above reasons, the 14.4V cordless power tool system is poor in the power output performance and the run time which starts after one full charge cycle of the battery pack when working under heavy loaded conditions, relative to the 36V cordless power tool system.

Alternatively, for the 36V cordless power tool system, the system design has been specialized to offer advantages, i.e., outperformed power output performance and reduced run time starting after one full charge cycle of the battery pack; and a reduction in running cost of the cordless power tool system, which results from elongation of life cycle of battery cells which is provided by a reduction in a current in the load, both relative to the 14.4V cordless power tool system. For these reasons, the battery pack has a maximum weight below which the user feels it possible to carry the 36V cordless power tool system, and the 36V cordless power tool system requires high initial cost because the battery pack and its charger are built up to have relatively high capacity of electric power.

In addition, because the 36V cordless power tool outputs at a poorer level than an AC power tool, the user is forced to do work using such a conventional cordless power tool as a temporary tool where the user cannot tap the commercial power source with ease, with lowered the working efficiency.

Moreover, a battery pack stores electric power with limited capacity, resulting in a limited length of run time staring after one full charge cycle of the battery pack. For this reason, the user cannot use a power tool combined with such a battery pack without any breaks, unlike an AC power tool. As a result, there is a conventional cordless power tool which can act temporarily as a corded DC power tool when used in electrical connection with an AC-DC converter device, for allowing the user to do continuous work.

Indeed the cordless power tool allows the user to do continuous work when used in electrical connection with an AC-DC converter device, but this tool is low in power output performance because of its low drive voltage relative to that of the commercial power source, requiring additional cost for circuitry for preventing the AC-DC converter device from being heated, with incapability of enduring heavy loaded work because of the need for protecting the circuitry from large load-current.

From the foregoing explanation, it is evident that there is no cordless power tool system which is highly evaluated because of a good balance between the weight, the level of power output, the length of run time, initial cost and running cost, all of a battery pack.

With respect to power output performance, in particular, a conventionally existing battery pack for use in cordless power tools has a maximum voltage of 36 V or volts, with a large difference in power output performance from the commercial power source which has a voltage of 100 volts. Due to this, there is no cordless power tool which can output power at a level which is comparable to that of an AC power tool, and there is no battery pack which can output power at a level which is comparable to that of the commercial power source, to say nothing of the fact that there is no battery pack of a type that can output voltage exceeding 36 volts, while satisfying all the user's demands as described above.

In addition, for hypothetically creating a handy battery pack using such a number of inner battery cells as to totally generate a voltage comparable to that of the commercial power source, it can be proposed designing the battery pack, according to a conventional underlying technique, to have: a battery cell group having 108 volts in the form of a serial connection of twenty-seven (27) Li-ion battery cells each of which has 4 volts just after fully charged; discharge control circuitry electrically connected with the battery cell group; and an output terminal electrically connected with the discharge control circuitry, with these components housed within a casing.

This battery pack, however, would cause a high voltage of 108 volts at a maximum to apply to inner segments frequently. In this case, phenomena are predicted which is likely to lose reliability in the electrical insulation, that is, the dielectric breakdown within the battery pack, which had not occurred in a conventional battery pack outputting 36 volts or less, because the voltage is significantly lower than that of the commercial power source; or the electrical leakage to the exterior of the battery pack due to introduction of foreign matters from outside of the battery pack, or the like.

In addition, to eliminate the above-described drawbacks when the battery cell group having a high DC voltage is housed within the battery pack, there is an approach in which the battery cell group is configured so as to have a DC voltage of 36 volts or lower in the form of a serial connection of battery cells, and an AC voltage is produced by boosting up the DC voltage of the battery cell group using a booster circuit, and by converting the boosted voltage into an AC voltage using a DC-AC converter circuit.

This approach, however, would increase load current of the battery cells, resulting in undesirable heat generation in both the battery cells and the booster circuit. The larger a difference between the DC voltage of the battery cell group and the effective value of the AC voltage at a final output stage, the more steeply the above-described heat generation increases. Incorporation of a device for eliminating or reducing the heat generation into a battery pack would cause a still additional drawback, for example, that the battery pack requires a large increase in size and cost, relative to a battery pack for use in a conventional cordless power tool.

In view of the foregoing, it would be preferable to provide a battery pack which uses battery cells in a manner that can improve the electrical-insulation reliability with easier than before.

According to some aspects of the invention, a battery pack usable as a power source for an electric device is provided.

This battery pack comprises:

a battery cell group of a plurality of battery cells which are interconnected in series;

discharge control circuitry for performing discharge control for the battery cell group; and

a discharge output terminal through which a discharge output of the battery cell group is supplied to the electric device,

wherein the battery cell group cooperates with an input/output terminal electrically connected with the battery cell group to constitute a battery module,

the battery module is serially connected with another or other battery modules to constitute a battery module group, and

the battery module group is electrically connected with the discharge control circuitry,

the battery pack further comprising:

a first detector detecting at least one of a voltage, a temperature and a current, of at least one of the battery cells in the battery cell group; and

a first selector configured to select one of a mode in which output of a voltage through the input/output terminal is enabled, and a mode in which the output of a voltage is disabled,

wherein the discharge control circuitry transmits to the first selector a first signal indicating that output of a voltage to the discharge output terminal is disabled, when the discharge control circuitry attempts to disable the output of a voltage to the discharge output terminal, based on a detection result of the first detector, and

the first selector, based on the first signal received from the discharge control circuitry, disables the output of a voltage through the input/output terminal.

It is noted here that, as used in this specification, the singular form “a,” “an,” and “the” include plural reference unless the context clearly dictates otherwise. It is also noted that the terms “comprising,” “including,” and “having” can be used interchangeably.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a perspective view illustrating the exterior of a battery pack according to a first embodiment of the present invention;

FIG. 2 is a perspective view illustrating the exterior of a cordless power tool according to an exemplary embodiment of the present invention;

FIG. 3 is a perspective view illustrating the exterior of the bottom of the cordless power tool depicted in FIG. 2;

FIG. 4 is a perspective view illustrating the exterior of an electrical cord adaptor according to an exemplary embodiment of the present invention;

FIG. 5 is a perspective view illustrating the exterior of the bottom of the electrical cord adaptor depicted in FIG. 4;

FIG. 6 is a perspective view illustrating the exterior of an electrical cord for charging the battery pack depicted in FIG. 1;

FIG. 7 is a perspective view illustrating the exterior of an AC power tool;

FIG. 8 illustrates in functional block diagram, the battery pack depicted in FIG. 1 and the cordless power tool depicted in FIG. 2, when interconnected;

FIG. 9 illustrates in functional block diagram, the battery pack depicted in FIG. 1 and the AC power tool depicted in FIG. 7, when interconnected;

FIG. 10 illustrates in functional block diagram, the battery pack depicted in FIG. 1 and the electrical cord, when interconnected;

FIG. 11 illustrates in functional block diagram, the battery pack depicted in FIG. 1 and the electrical cord adaptor, when interconnected;

FIG. 12 illustrates in functional block diagram, the cordless power tool depicted in FIG. 2 and the electrical cord adaptor, when interconnected;

FIG. 13 is an exploded perspective view of the battery pack depicted in FIG. 1;

FIG. 14 is a side view illustrating the interior structure of a battery module according to an exemplary embodiment of the present invention;

FIG. 15 is a top view illustrating the interior structure of the battery module depicted in FIG. 14;

FIG. 16 is a functional block diagram illustrating the battery module depicted in FIG. 14;

FIG. 17 is a side view illustrating the interior structure of the battery pack depicted in FIG. 1;

FIG. 18 is a top view illustrating the interior structure of the battery pack depicted in FIG. 1;

FIG. 19 is a functional block diagram illustrating the battery pack depicted in FIG. 1;

FIG. 20 is a side view illustrating the interior structure of the battery pack depicted in FIG. 1 and the cordless power tool depicted in FIG. 2, when interconnected;

FIG. 21 is a side view illustrating the interior structure of the battery pack depicted in FIG. 1 and an outlet plug, when interconnected;

FIG. 22 is a side view illustrating the interior structure of the battery pack depicted in FIG. 1 and the electrical cord for charging, when interconnected;

FIG. 23 is a side view illustrating the interior structure of the battery pack depicted in FIG. 1 and the electrical cord adaptor, when interconnected;

FIG. 24 is a side view illustrating the interior structure of the cordless power tool depicted in FIG. 2 and the electrical cord adaptor, when interconnected;

FIG. 25 is a flowchart in conjunction with a basic operation of the battery pack depicted in FIG. 1;

FIG. 26 is a flowchart in conjunction with a long-term storage mode of the battery pack depicted in FIG. 1;

FIG. 27 is a flowchart in conjunction with a charge preparation mode of the battery pack depicted in FIG. 1;

FIG. 28 is a flowchart in conjunction with a charge mode of the battery pack depicted in FIG. 1;

FIG. 29 is a flowchart in conjunction with a discharge preparation mode of the battery pack depicted in FIG. 1;

FIG. 30 is a flowchart in conjunction with a discharge mode of the battery pack depicted in FIG. 1;

FIG. 31 is a functional block diagram illustrating a battery module according to a second embodiment of the present invention;

FIG. 32 is a functional block diagram illustrating a battery pack according to the second embodiment of the present invention;

FIG. 33 is a functional block diagram illustrating a battery module according to a third embodiment of the present invention;

FIG. 34 is a functional block diagram illustrating a battery pack according to the third embodiment of the present invention;

FIG. 35 is a functional block diagram illustrating a battery module according to a fourth embodiment of the present invention;

FIG. 36 is a functional block diagram illustrating a battery pack according to the fourth embodiment of the present invention and an electric device; and

FIG. 37 is a functional block diagram illustrating the battery pack according to the fourth embodiment of the present invention and a charger.

### DETAILED DESCRIPTION OF THE INVENTION

According to the invention, the following modes are provided as illustrative embodiments of the invention:

(1) A battery pack usable as a power source of an electric device, comprising:

a battery cell group of a plurality of battery cells which are interconnected in series;

discharge control circuitry for performing discharge control for the battery cell group;

discharge output terminal through which a discharge output of the battery cell group is supplied to the electric device; and

a casing within which the battery cell group, the discharge control circuitry and the discharge output terminal are housed,

wherein the battery cell group cooperates with an input/output terminal electrically connected with the battery cell group to constitute a battery module,

the battery module is serially connected with another or other battery modules to constitute a battery module group, and

the battery module group is electrically connected with the discharge control circuitry,

the battery pack further comprising;

a first detector detecting at least one of a voltage, a temperature and a current, of at least one of the battery cells in the battery cell group; and

a first selector configured to select one of a mode in which output of a voltage through the input/output terminal is enabled, and a mode in which the output of a voltage is disabled,

wherein the discharge control circuitry transmits to the first selector a first signal indicating that output of a voltage to the discharge output terminal is disabled, when the discharge control circuitry attempts to disable the output of a voltage to the discharge output terminal, based on a detection result of the first detector, and

the first selector, based on the first signal received from the discharge control circuitry, disables the output of a voltage through the input/output terminal.

This battery pack would allow, after interruption of the discharging of the battery cell group, the first selector to electrically insulate the battery cells from each other or one another, with improved electrical-insulation reliability of the battery cells while the battery cells are not being discharged.

(2) A battery pack usable as a power source for an electric device, comprising:

a battery cell group of a plurality of battery cells which are interconnected in series;

discharge control circuitry for performing discharge control for the battery cell group;

a discharge output terminal through which a discharge output of the battery cell group is supplied to the electric device; and

a casing within which the battery cell group, the discharge control circuitry and the discharge output terminal are housed,

wherein the battery cell group cooperates with an input/output terminal electrically connected with the battery cell group to constitute a battery module,

the battery module is serially connected with another or other battery modules to constitute a battery module group,

each of the serially-interconnected battery modules includes module control circuitry configured to control a status of each battery module in a selected one of a voltage output mode which enables output of a voltage to the input/output terminal, and an output disable mode which disables the output of a voltage to the input/output terminal,

the module control circuitry within each battery module, upon selection of the output disable mode, transmits an output disable signal indicating that the output of a voltage to the input/output terminal is disabled, to the module control circuitry within each of the rest of the battery modules in the battery pack, and

the module control circuitry within each battery module, upon reception of the output disable signal, disables the output of a voltage to the input/output terminal.

This battery pack would allow, after interruption of the discharging of the battery cell group, the module control circuitry to electrically insulate the battery cells from each other or one another, with improved electrical-insulation reliability of the battery cells while the battery cells are not being discharged.

(3) A battery pack usable as a power source for an electric device, comprising:

a battery cell group of a plurality of battery cells which are interconnected in series;

charge control circuitry for charging the battery cell group; and

a casing within which the battery cell group and the charge control circuitry are housed,

wherein the battery cell group cooperates with an input/output terminal electrically connected with the battery cell group to constitute a battery module,

the battery module is serially connected with another or other battery modules to constitute a battery module group, and

the battery module group is electrically connected with the charge control circuitry,

the battery pack further comprising:

a second detector detecting at least one of a voltage, a temperature and a current, of at least one of the battery cells in the battery cell group; and

a second selector configured to select one of a mode in which input of a voltage to the battery cell group is enabled, and a mode in which the input of a voltage is disabled,

wherein the charge control circuitry transmits to the second selector a second signal indicating that input of a voltage to the battery module group is disabled, when the charge control circuitry attempts to disable the input of a voltage to the battery module group, based on a detection result of the second detector, and

the second selector, based on the second signal received from the charge control circuitry, disables the input of a voltage to the battery cell group.

This battery pack would allow, after interruption of the charging of the battery cell group, the second selector to electrically insulate the battery cells from each other or one another, with improved electrical-insulation reliability of the battery cells while the battery cells are not being charged.

(4) A battery pack usable as a power source for an electric device, comprising:

a battery cell group of a plurality of battery cells which are interconnected in series;

charge control circuitry for charging the battery cell group; and

a casing within which the battery cell group and the charge control circuitry are housed,

wherein the battery cell group cooperates with an input/output terminal electrically connected with the battery cell group to constitute a battery module,

the battery module is serially connected with another or other battery modules to constitute a battery module group, and

the battery module group is electrically connected with the charge control circuitry,

each of the serially-interconnected battery modules includes module control circuitry configured to control a status of each battery module in a selected one of a voltage input mode which enables input of a voltage to the battery cell group, and an input disable mode which disables the input of a voltage to the battery cell group,

the module control circuitry within each battery module, upon selection of the input disable mode, transmits an input disable signal indicating that the input of a voltage to the battery cell group is disabled, to the module control circuitry within each of the rest of the battery modules in the battery pack, and

the module control circuitry within each battery module, upon reception of the input disable signal, disables the input of a voltage to the battery cell group.

This battery pack would allow, after interruption of the charging of the battery cell group, the module control circuitry to electrically insulate the battery cells from each other or one another, with improved electrical-insulation reliability of the battery cells while the battery cells are not being charged.

(5) A power tool unit comprising:

a cordless power tool;

a battery pack which is detachably attached to the cordless power tool for supply of electrical power to the cordless power tool; and

an electrical cord adaptor which is detachably attached to the cordless power tool and the battery pack for supply of electrical power,

wherein the cordless power tool includes a male-outlet-type power-input terminal, and a dummy recess having a recessed exterior made of electrically-insulating material,

the battery pack includes a charging inlet having recessed exterior made of electrically-insulating material, and a female discharging outlet into which the power-input terminal is to be inserted, and

the electrical cord adaptor includes a charging power-supply terminal which is to be inserted into the dummy recess and the charging inlet selectively, and has a protruded exterior made of electrically-insulating material, and a female-outlet-type power-supply terminal into which the power-input terminal is to be inserted.

This power tool unit would allow a user to use any one of combinations of two of three components, that is, the battery pack, the cordless power tool and the electrical cord adaptor, without causing any interference between two mating connections of each combination of two components.

(6) A power tool unit comprising:

a cordless power tool;

a battery pack which is detachably attached to the cordless power tool for supply of electrical power to the cordless power tool; and

an electrical cord adaptor which is detachably attached to the cordless power tool and the battery pack for supply of electrical power,

wherein the cordless power tool includes a female-outlet-type power-input terminal, and a dummy recess having a recessed exterior made of electrically-insulating material,

the battery pack includes a charging inlet having a recess exterior made of electrically-insulating material, and a male discharging outlet which is to be inserted into the power-input terminal, and

the electrical cord adaptor includes a charging power-supply terminal into which the dummy recess and the charging inlet are to be selectively inserted and which has a protruded exterior made of electrically-insulating material, and a male-outlet-type power-supply terminal which is to be inserted into the power-input terminal.

This power tool unit would allow a user to use any one of combinations of two of three components, that is, the battery pack, the cordless power tool and the electrical cord adaptor, without causing any interference between two mating connections of each combination of two components.

(7) A battery pack comprising:

a plurality of battery cells;

input/output terminals electrically connected with the the plurality of battery cells; and

a discharge output terminal shared with the plurality of battery cells,

the battery pack further comprising:

circuitry for measuring a length of a non-use time during which the battery pack is not used for electrical purposes; and

circuitry for disabling a current flow through the input-output terminal, if the measured non-use time exceeds a predetermined length of time.

The battery pack would allow, while the battery pack remains unused, a device for interrupting current flow through the input-output terminal, to electrically insulate the battery cells from each other or one another, with improved electrical-insulation reliability of the battery cells while the battery pack is not being used.

(8) A battery pack comprising:

a plurality of battery cells;

input/output terminals electrically connected with the plurality of battery cells; and

a discharge output terminal shared with the plurality of the battery cells,

the battery pack further comprising:

circuitry for determining whether an outlet plug of the electric device has been connected with the discharge output terminal; and

circuitry for disabling output of at least one of the input/output terminal and the discharge output terminal, if the outlet plug of the electric device has not been connected with the discharge output terminal, or if the battery pack has been unused for a predetermined length of time or more, with the outlet plug of the electric device connected with the discharge output terminal.

This battery pack would allow, while the battery pack remains unused, a device for interrupting at least one of current flow through the input-output terminal and through the discharge output terminal, to electrically insulate the battery cells the discharge output terminal from each other, with improved electrical-insulation reliability of the battery cells while the battery pack is not being used.

(9) A battery pack usable as a power source of an electric device, comprising:

a battery cell group of a plurality of battery cells which are interconnected in series;

discharge control circuitry for performing discharge control for the battery cell group;

discharge output terminal through which a discharge output of the battery cell group is supplied to the electric device; and

a casing within which the battery cell group, the discharge control circuitry and the discharge output terminal are housed,

wherein the battery cell group cooperates with an input/output terminal electrically connected with the battery cell group to constitute a battery module,

each battery cell is cylindrical around a cell axis,

the plurality of battery cells are electrically interconnected in series, on a per-battery-module basis,

each battery module has an electrically insulative module housing with a hollow rectangle shape,

a sub-plurality of the plurality of battery cells are housed within each battery module, in a planar geometric array, such that the cell axes of the sub-plurality of battery cells are in parallel, on a per-battery-module basis, and

a plurality of battery modules belonging to the battery module group are housed in the casing, in a series geometric array,

the battery pack further comprising an electrically insulative spacer providing a clearance between facing exterior walls of adjacent ones of the plurality of battery modules in the series geometric array,

wherein the facing exterior walls of the adjacent battery modules are in contact with each other via the spacer.

This battery pack would allow the electrically-insulating module housings of the facing exterior walls of the adjacent battery modules and the clearance (i.e., an electrically-insulating space) created between the facing exterior walls, to electrically insulate the adjacent battery modules from each other, resulting in improved electrical-insulation reliability of the battery cells over the entirety of the adjacent battery modules.

In addition, this battery pack would allow undesirable heat generated in the serially-connected battery cells within each battery module, to be emitted into the atmosphere via the clearance, resulting in improvement in the heat release-ability of each battery module.

In an exemplary implementation of this battery pack, the module housing of each battery module is made of a plurality of exterior walls, and two of these exterior walls are facing in a direction in parallel to the cell axes. In these two facing exterior walls, a plurality of protrusions are formed in contact with exterior walls of the module housing of another battery module which is adjacent to the each battery module. Each of the plurality of protrusions serves as the spacer in the battery pack set forth in the above mode (9).

In one arrangement of this implementation, the plurality of protrusions are divided into two groups, and the first and second groups are formed in the two facing exterior walls of each battery module, respectively. The first and second groups are not directly facing, that is, are staggered in a direction perpendicular to a direction in which the two facing exterior walls are facing, within the same module housing.

This arrangement would allow the protrusions formed on one of the two facing exterior walls of the module housing of one of the plurality of battery modules, and the protrusions formed on one of the two facing exterior walls of the module housing of an adjacent one of the rest of the battery modules, to be staggered. This would minimize a size of the battery pack when viewed in a direction that the plurality of battery modules are arrayed, and therefore, minimize a minimum volume of an inner space the case of the battery pack which is required for improving the electrical-insulation reliability within the battery pack.

In alternative exemplary implementation of the battery pack according to mode (9), electrically-insulating protrusions are formed on an interior wall of the casing of the battery pack, so as to protrude from the surface of the interior wall into between the adjacent ones of the battery modules, to thereby form a clearance between the adjacent battery modules, with each of the protrusions acting as the spacer set forth in mode (9).

(10) A battery pack usable as a power source for an electric device,

wherein the electric device outputs a voltage-property-indication signal indicative of a property of a voltage (e.g., one the followings, or one of combinations of the followings: a temporal change in the effective value of the voltage; a temporal change in the frequency of the voltage; a temporal change in the polarity of the voltage; a temporal change in the output level of the voltage; and a temporal change in the output interruption phases) to be supplied to the electric device, and

the battery pack further comprises:

a battery cell group in which a plurality of battery cells are interconnected in series;

an input terminal to which the voltage-property-indication signal is inputted; and

conversion circuitry (e.g., an inverter circuit) for converting a property of the voltage of the battery cell group into a property indicated by the voltage-property-indication signal inputted to the input terminal, to thereby output the voltage of the battery cell group to the electric device.

This battery pack would output to the electric device, a voltage having a desirable property to the electric device, that is, a voltage satisfying the voltage property which are desired by the electric device, to thereby eliminate or reduce the number of components which are required to be incorporated into the electric device for controlling the voltage to become available in the electric device.

(11) A battery pack usable as a power source for en electric device, wherein the electric device acts as an external device to the battery pack,

the battery pack comprising:

a battery cell group of a plurality of battery cells which are interconnected in series;

a discharge output terminal through which a discharge output of the battery cell group is supplied to the electric device; and

a casing within which the battery cell group and the discharge output terminal are housed,

wherein the electric device includes discharge control circuitry for performing discharge control for the battery cell group,

the battery cell group cooperates with an input/output terminal electrically connected with the battery cell group to constitute a battery module,

the battery module is serially connected with another or other battery modules to constitute a battery module group, and

the battery module group is electrically connected with the discharge control circuitry

the battery pack further comprising:

a first detector detecting at least one of a voltage, a temperature and a current, of at least one of the battery cells in the battery cell group; and

a first selector configured to select one of a mode in which output of a voltage to the input/output terminal is enabled, and a mode in which the output of a voltage is disabled,

wherein the discharge control circuitry transmits to the first selector a first signal indicating that output of a voltage to the discharge output terminal is disabled, when the discharge control circuitry attempts to disable the output of a voltage to the discharge output terminal, based on a detection result of the first detector, and

the first selector, based on the first signal received from the discharge control circuitry, disables output of a voltage to the input/output terminal.

This battery pack would allow, after interruption of the discharging of the battery cell group, the first selector to electrically insulate the battery cells from each other or one another, with improved electrical-insulation reliability of the battery cells while the battery cells are not being discharged.

(12) A battery pack usable as a power source for an electric device, comprising:

a battery cell group in which a plurality of battery cells are interconnected in series; and

a casing within which the battery cell group is housed,

wherein the battery cell group is charged with a charger which acts as an external device to the battery pack,

the charger includes charge control circuitry for performing charge control for the battery cell group,

the battery cell group cooperates with an input/output terminal electrically connected with the battery cell group to constitute a battery module,

the battery module is serially connected with another or other battery modules to constitute a battery module group,

the battery module group is electrically connected with the charge control circuitry,

the battery pack further comprising:

a second detector detecting at least one of a voltage, a temperature and a current, of at least one of the battery cells in the battery cell group; and

a second selector configured to select one of a mode in which input of a voltage to the battery cell group is enabled, and a mode in which the input of a voltage is disabled,

wherein the charge control circuitry transmits to the second selector a second signal indicating that input of a voltage to the battery module group is disabled, when the charge control circuitry attempts to disabled the input of a voltage, based on a detection result of the second detector, and

the second selector, based on reception of the second signal from the charge control circuitry, disables input of a voltage to the battery cell group.

This battery pack would allow, after interruption of the charging of the battery cell group, the second selector to electrically insulate the battery cells from each other or one another, with improved electrical-insulation reliability of the battery cells while the battery cells are not being charged.

(13) The battery pack according to any one of modes (1) through (12), wherein each of the serially-interconnected battery modules generates a voltage not exceeding 42 volts, at the input/output terminal.

(14) The battery pack according to any one of modes (1) through (13), wherein the battery pack generates a voltage not lower than 84 volts, at the discharge output terminal.

This battery pack can be implemented by the use of, for example, at least two battery modules each of which is set forth in the above mode (13).

(15) The battery pack according to any one of modes (1) through (14), wherein each of the serially-interconnected battery modules generates a nominal voltage not exceeding 36 volts, at the input/output terminal.

(16) The battery pack according to any one of modes (1) through (15), wherein the battery pack generates a nominal voltage not lower than 72 volts, at the discharge output terminal.

This battery pack can be implemented by the use of, for example, at least two battery modules each of which is set forth in the above mode (15).

There will be described below the features of battery packs according to other various aspects of the present invention or other devices.

According to an aspect of the invention, a battery pack usable as a power source for an electric device is provided, the battery pack comprising:

a battery cell group of a plurality of battery cells which are interconnected in series;

discharge control circuitry for performing discharge control for the battery cell group;

a discharge output terminal through which a discharge output of the battery cell group is supplied to the electric device (e.g., in a manner that converts DC into AC for supply of AC to the electric device or a manner that directly supplies DC to the electric device); and

a casing within which the battery cell group, the discharge control circuitry and the discharge output terminal are housed,

wherein the battery cell group cooperates with an input/output terminal electrically connected with the battery cell group to constitute a battery module,

the battery module is serially connected with another or other battery modules to constitute a battery module group, and

the battery module group is electrically connected with the discharge control circuitry,

the battery pack further comprising:

a first detector detecting at least one of a voltage, a temperature and a current, of at least one of the battery cells in the battery cell group; and

a first selector configured to select one of a mode (i.e., a discharging mode) in which output of a voltage to the input/output terminal is enabled, and a mode (i.e., a discharge interrupting mode) in which the output of a voltage is disabled (this selector may be in the form of, for example, a switch which is disposed inside or outside of the casing),

wherein the discharge control circuitry transmits to the first selector a first signal indicating that the output of a voltage to the discharge output terminal is disabled, when the discharge control circuitry attempts to disable the output of a voltage to the discharge output terminal, based on a detection result of the first detector, and

the first selector, based on the first signal received from the discharge control circuitry, disables the output of a voltage to the input/output terminal.

This battery pack would allow, after interruption of the discharging of the battery cells, the battery cells to be electrically insulated from each other or one another, with improved electrical-insulation reliability while the battery cells are not being discharged.

According to another aspect of the invention, a battery pack usable as a power source for an electric device is provided, the battery pack comprising:

a battery cell group of a plurality of battery cells which are interconnected in series;

charge control circuitry for charging the battery cell group (e.g., in a manner that allows the battery cells to be charged with DC from the beginning, or a manner that converts AC into DC and charges the battery cells with DC); and

a casing within which the battery cell group and the charge control circuitry are housed,

wherein the battery cell group cooperates within an input/output terminal electrically connected with the battery cell group to constitute a battery module,

the battery module is serially connected with another or other battery modules to constitute a battery module group, and

the battery module group is electrically connected with the charge control circuitry,

the battery pack further comprising:

a second detector detecting at least one of a voltage, a temperature and a current, of at least one of the battery cells in the battery cell group; and

a second selector configured to select one of a mode (i.e., a charging mode) in which input of a voltage to the battery cell group is enabled, and a mode (i.e., charging interrupting mode) in which the input of a voltage is disabled (this selector may be in the form of, for example, a switch which is disposed inside or outside of the casing),

wherein the charge control circuitry transmits to the second selector a second signal indicating that input of a voltage to the battery module group is disabled, when the charge control circuitry attempts to disabled the input of a voltage to the battery module group, based on a detection result of the second detector, and

the second selector, based on the second signal received from the charge control circuitry, disables the input of a voltage to the battery cell group.

This battery pack would allow the battery cells to be protected from being abnormally charged, with improved reliability in the charge control.

According to still another aspect of the invention, a battery pack usable as a power source for an electric device is provided, in which there are housed within a case,

(a) a battery cell group of a plurality of battery cells which are interconnected in series;

(b) discharge control circuitry for converting DC voltage of the battery cell group into AC voltage; and

(c) an AC-output terminal through which an output of the discharge control circuitry is supplied to the electric device (i.e., one example of the above-described “discharge output terminal”).

In one exemplary implementation of the invention, an approach is employed of converting a DC voltage of a group of two or more serially-connected battery cells into an AC voltage. For this approach to be implemented, if a conventional technique is applied in which a casing is used to house: a battery cell group of a plurality of battery cells which are serially-connected; voltage monitor wires electrically connected with the battery cells of the battery cell group; a control section electrically connected with the voltage monitor wires; and a discharge terminal electrically connected with the control section, then, due to very high voltage of the battery cell group, many locations, such as locations between the battery cells having mutually different voltages, locations between the voltage monitor wires, space between the voltage monitor wires and the battery cells, and locations between the discharging terminals having opposite polarities, are high in electrical potential, to thereby invite additional drawbacks with regard to electrical insulation, such as the complexity of the interior structure of the battery pack for ensured electrical insulation, and the dielectric breakdown due to introduction of foreign matters.

For example, if a conventional battery pack is designed to use a battery cell group in the form of a serial connection of twenty-seven (27) Li-ion battery cells each of which has 4 volts just after fully charged, then 108 volts at the maximum would be frequently impressed onto the above-described each location. The interior structure which has been employed in the conventional battery pack for accommodating 36 volts or lower, would lose electrical-insulation reliability, because the conventional battery pack has not been designed to cope with frequent times of impression of 108 volts at the maximum.

In addition, a conventional charger charges a battery pack by conversion of the commercial power source voltage into a DC voltage and by DC voltage reduction for isolation. For the conventional charger in combination with the battery pack, duplicate protection is provided in which, if the charger is failed when charging the battery pack, then the battery pack itself disables the charging, and, if the battery pack is failed when being charged, then the charger itself disables the charging.

In an exemplary implementation of the invention, the battery pack is used, which has the battery cell group configured to be effective in solving the aforementioned insulation-related problems, without requiring voltage reduction for isolation which is typically implemented in a conventional charger. This makes it possible to incorporate a simplified DC converter into the battery pack, and to charge the battery pack with the commercial power source in electrical connection with each other via only their electrical cord. In this case, however, the commercial power source side cannot be controlled from the battery pack side, and therefore, if the battery pack side is failed when being charged, then the charging cannot be stopped, with an additional need for duplicate protection.

In one exemplary implementation of the invention, a power tool system is configured to include: a battery pack configured to output alternating current voltage which is higher than 36 volts, particularly equivalent to a commercial power source; a cordless power tool to be operated in electrical connection with the battery pack; an electrical cord allowing the battery pack to be connected with the commercial power source, for charging the battery pack; a power source cord adaptor allowing the battery pack to be connected with the commercial power source, for charging the battery pack; and a power source cord adaptor allowing the cordless power tool to be connected with commercial power source, for continuous supply of electrical power from the commercial power source to the cordless power tool, or otherwise a power source cord adaptor for use in both charging of the battery pack, and continuous use of the cordless power tool.

It is added that load devices contemplated here to which a battery pack discharges power include, but not limited in type to power tools, a wide variety of electric devices which can be used similarly with implementations of the present invention.

A battery pack according to an exemplary embodiment of the present invention is constructed to include: a battery cell group of a plurality of battery cells which are serially interconnected and which has a total voltage of above 36 volts; discharge control circuitry for converting a DC voltage of the battery cell group into an AC voltage; and AC-output terminal for supplying the output of the discharge control circuitry to a power tool, with these components housed within a casing.

This battery pack would at least in part solve a problem of durability of one or more switches in the power tool under high voltage conditions, while outputting a voltage of above 36 volts.

In addition, if the AC voltage of the battery pack has its effective value which is selected so as to include the same as the effective value of the commercial power source voltage, and if the AC voltage of the battery pack has its frequency which is selected so as to include the same as the frequency of the commercial power source, then the electricity which is comparable to that of the commercial power source can be supplied to a cordless power tool according to an exemplary embodiment of the present invention.

This battery pack would at least in part solve problems with regard to output, runtime, initial cost and running cost.

Additionally, if the AC-output terminals described above is made insertable into an outlet plug of an AC power tool for electricity input, then the AC power tool will become available, which solves a problem that a conventional cordless power tool, which is short of output power, can be used only for temporarily uses.

A battery pack according to an exemplary embodiment of the present invention is configured to include a connect/disconnect device (e.g., a switch such as a transistor) disposed between battery cells in a battery cell group, wherein the discharge control circuitry allows, in a state in which the battery cells are not permitted to be charged, the connect/disconnect device to disconnect the battery cells from each other or one another.

This battery pack would at least in part solve a problem with regard to the electrical isolation or separation in the very-high-voltage battery cell group.

A battery pack according to an exemplary embodiment of the present invention is constructed to include: a battery cell group of battery cells which are serially interconnected, whose number is smaller than a total number of the battery cells within the battery pack; and battery module control circuitry for controlling a DC voltage of the battery cell group.

In this arrangement, the battery cell group and the battery module control circuitry together constitute a battery module which is housed within an outer enclosure such that the battery module is exposed only at input/output terminals which are electrically connected with the module control circuitry. A plurality of battery modules are electrically connected in series into a battery module group, which is electrically connected with discharge control circuitry and is housed within a casing of the battery pack.

This battery pack would at least in part solve problems with regard to the complexity in the interior structure of the battery pack and the electrical isolation or separation in the battery pack.

In addition, the battery module has battery module control circuitry which has a detector detecting at least one of a voltage, a temperature and a current, of at least one of the battery cells, and a selector configured to select one of a mode in which output of a DC voltage of the battery cell group to the input/output terminal is enabled, and a mode in which the output of a DC voltage is disabled, based on a detection result of the detector.

This battery pack would at least in part solve problems with regard to the complexity in the interior structure of the battery pack and the electrical isolation or separation in the battery pack.

The discharge control circuitry and the battery module control circuitry may be implemented in a mode that they transmit/receive a signal indicating that the discharge is disabled, in one of the following directions: a direction from the discharge control circuitry to the battery module control circuitry: both directions between the discharge control circuitry and the battery module control circuitry; and a both directions between a plurality of units of the battery module control circuitry for the plurality of battery modules within the battery pack.

In this mode, if the discharge control circuitry disables the outputting action, then the discharge control circuitry transmits a signal indicating that the outputting action of the discharge control circuitry is disabled, to the battery module control circuitry. If the battery module control circuitry disables the outputting action of the battery module control circuitry, then the battery module control circuitry transmits a signal indicating that the outputting action of the battery module control circuitry is disabled, to the discharge control circuitry, or the battery module control circuitry for the rest of the battery modules within the battery pack.

In this mode, the discharge control circuitry and the battery module control circuitry, upon reception of the signal, disable their outputting actions in their own manners.

This battery pack would at least in part solve problems with regard to the complexity in the interior structure of the battery pack and the electrical isolation or separation in the battery pack.

In addition, the discharge control circuitry may be configured to include a detector configured to detect at least one of a voltage, a temperature and a current, for each of the battery modules within the battery module group, and a device for selectively enabling and disabling the output of an AC voltage to the input/output terminal, based on a detection result of the detector.

This battery pack would at least in part solve problems with regard to the complexity in the interior structure of the battery pack and the electrical isolation or separation in the battery pack.

A battery pack according to an exemplary embodiment of the present invention is configured to include: a detector configured to detect entry into an electrical connection state in which an outlet plug that is power-input terminals of an AC power tool, is connected to AC output terminals; and discharge control circuitry configured to selectively enable and disable the output of an AC voltage to the AC output terminals, based on a detection result of the detector.

This battery pack would at least in part solve a problem with regard to the electrical isolation or separation in the battery pack.

In addition, the aforementioned detector, which detects connection of the outlet plug with the AC output terminals, may be in the form of a cover which is movable integrally with the insertion movement of the outlet plug, and a switch is changeable in state with the movement of the cover.

This arrangement would at least in part solve problems with regard to the electrical isolation or separation in the battery pack.

A battery pack according to an exemplary embodiment of the present invention has a charging terminal, and charge control circuitry configured to convert an input voltage from a commercial power source through the charging terminal, into a DC voltage, and to control the DC voltage, which allows the battery pack to be charged by connecting an electrical cord with the charging terminal, without requiring use of any charger. This would at least in part solve problems with regard to the initial cost.

In addition, an example in which the battery module control circuitry includes a detector configured to detect at least one of a voltage, a temperature and a current, for the battery cells, and a device for selectively enabling an disabling the input of a DC voltage to the battery cell group, based on a detection result from the detector, would at least in part solve problems with regard to the duplicate protection during charging.

The charge control circuitry and the battery module control circuitry may be implemented in a mode that they transmit/receive a signal indicating that the charge is disabled, in one of the following directions: a direction from the charge control circuitry to the battery module control circuitry, both directions between the charge control circuitry and the battery module control circuitry, and both directions between a plurality of units of the battery module control circuitry for the of a plurality of the battery modules within the battery pack.

In this mode, if the charge control circuitry disables charging, then the charge control circuitry transmits a signal indicating that charging is disabled to the battery module control circuitry, and alternatively, if the battery module control circuitry disables charging, then the battery module control circuitry transmits the signal to the charge control circuitry, or the battery module control circuitry for the rest of the battery modules within the battery pack.

In this mode, the charge control circuitry and the battery module control circuitry, upon reception of the signal, disable their respective charging actions, in their own manners.

This would provide the solution of problems with respect to the duplicate protection during charging and the electrical isolation or separation.

The charge control circuitry may have a detector configured to detect at least one of a voltage, a temperature and a current for each of the battery modules within the battery module group, and a device for selectively enabling and disabling the input of a DC voltage to the battery module group, based on a detection result from the detector.

This arrangement would at least in part solve problems with regard to the duplicate protection during charging and the electrical isolation or separation.

In addition, the charge control circuitry may have a detector configured to detect entry into an electrical connection in which power-supply terminals that delivers electricity from outside of the battery pack, is connected to the charging terminals, and a device for selectively enabling and disabling the input of a DC voltage to the battery module group, based on a detection result from the detector.

This arrangement would at least in part solve a problem with regard to the electrical isolation or separation.

A battery cell in the battery pack according to an exemplary embodiment of the present invention may be a Li-ion battery, in particular, which would at least in part solve problems with regard to the weight, the output, the initial cost, and running cost, of a cordless power tool when the present invention is practiced, totally and effectively.

An electrical cord adaptor according to an exemplary embodiment of the present invention includes: a casing in which a guide made of electrically-insulating material is formed for attachment to a battery pack according to an exemplary embodiment of the present invention; a power-supply terminal which is electrically connected with a charging terminal of the battery pack; and an electrical cord through which an AC voltage is supplied from the commercial power source to the power-supply terminal.

Because this arrangement allows the battery pack to be charged as a result of connection of the battery pack to the electrical cord adaptor, without requiring use of any charger, this arrangement would at least in part solve a problem with regard to the initial cost.

An electrical cord adaptor may include a guide for attachment to a cordless power tool according to an exemplary embodiment of the present invention, and a power-supply terminal through which an AC voltage is supplied from the commercial power source to a power-input terminal of the cordless power tool.

This arrangement would at least in part solve a problem with regard to the runtime and the initial cost.

In this regard, a conventional technology has a problem because they cannot allow a connecting structure for connecting a connector of the electrical cord adaptor to a connector the battery pack for the purpose of charging the battery pack, and a connecting structure for connecting the connector of the electrical cord adaptor to a connector of the cordless power tool for the purpose of supplying power from the electrical cord adaptor to the cordless power tool, to be identical with each other. This problem will be elaborated below.

Each of the connectors of these three components, that is, the electrical cord adaptor, the battery pack, and the cordless power tool, can take a shape as a selected one of a male type (i.e., a protrusion) and a female type (i.e., a recess).

If, for the purpose of charging the battery pack using the electrical cord adaptor, the connector of the battery pack takes a shape of a female type, the connector of the electrical cord adaptor takes a shape a male type, and if, for the purpose of activating the cordless power tool using the battery pack, the connector of the battery pack still takes of a female type, then the connector of the cordless power tool has to take of a male type.

If, however, we attempt to connect the electrical cord adaptor to the cordless power tool for the purpose of directly supplying power from the commercial power source to the cordless power tool without using the battery pack, then the connector of the electrical cord adaptor and the connector of the cordless power tool each take a shape of a male type. This causes a problem that these connectors cannot be mated with each other, with incapability of mutual connection.

Then, according to an exemplary embodiment of the invention, a battery pack, an electrical cord adaptor and a cordless power tool are provided, and the cordless power tool is configured to include: a protruded power-input terminal used when the cordless power tool is powered by the electrical cord adaptor; and a dummy recess which can be engaged mechanically but electrically with a counterpart (which does not provide electrical connection, but provides mechanical connection).

This connector structure allows any one of combinations of any two of those three components to be mated with each other, at least in part solving problems with regard to the connector mating possibility and the initial cost.

More specifically, an exemplary power tool unit is provided, comprising:

a cordless power tool;

a battery pack which is detachably attached to the cordless power tool for supply of electrical power; and

an electrical cord adaptor which is detachably attached to the cordless power tool and the battery pack for supply of electrical power,

wherein the cordless power tool includes a male-outlet-type power-input terminal, and a dummy recess having a recessed exterior made of electrically-insulating material, and a female discharging outlet into which the power-input terminal is to be inserted, and

the electrical cord adaptor includes a charging power-supply terminal which is to be inserted into the dummy recess and the charging inlet selectively and has a protruded exterior made of electrically-insulating material, and a female-outlet-type power-supply terminal into which the power-input terminal is to be inserted.

An alternative power tool unit is provided, comprising:

a cordless power tool;

a battery pack which is detachably attached to the cordless power tool for supply of electrical power; and

an electrical cord adaptor which is detachably attached to the cordless power tool and the battery pack for supply of electrical power,

wherein the cordless power tool includes a female-outlet-type power-input terminal, and a dummy recess having a recessed exterior made of electrically-insulating material,

the battery pack includes a charging inlet having a recessed exterior made of electrically-insulating material, and a male discharging outlet which is to be inserted into the power-input terminal, and

the electrical cord adaptor includes a charging power-supply terminal into which the dummy recess and the charging inlet are to be selectively inserted and which has a protruded exterior made of electrically-insulating material, and a male-outlet-type power-supply terminal which is to be inserted into the power-input terminal.

Then, there will be described advantageous effects of the battery pack which is constructed according to each of various aspects of the invention or other devices, with respect to output performance.

A cordless power tool according to an exemplary embodiment of the present invention operates such that a battery pack supplies to an AC motor an AC voltage of above 36 volts, which is such as 48 volts, 72 volts or 100 volts. Therefore, as the output level of a cordless power tool according to an exemplary embodiment of the present invention becomes closer to the same as the commercial power source, such a cordless power tool can show increasing differences in output level from a conventional cordless power tool powered by a voltage of 14.4 volts or 36 volts.

A battery cell within a battery pack has the internal resistance, and, during discharge, consumes energy whose amount varies proportional to the square of the loading current value of the battery cell, in the form of heat emission from the battery cell. In a cordless power tool according to an exemplary embodiment of the present invention, the loading current of the cordless power tool, particularly when the toll is powered by the same as a voltage of the commercial power source, remarkably small in comparison with the loading current in a conventional cordless power tool powered by a voltage of 14.4 volts or 36 volts.

Therefore, in a battery pack according to an exemplary embodiment of the present invention, the energy which is consumed in the form of heat emission is minor in comparison with a conventional battery pack having an output voltage of 14.4 volts or 36 volts.

In addition, in a battery pack according to an exemplary embodiment of the present invention, because the battery pack outputs an AC voltage having a level which is the same as the effective value of the commercial power source, discharge output terminals can be provided which are connectable with an outlet plug for use with the commercial power source. Therefore, the battery pack can be used to power even a conventional AC power tool, with its electrical cord connected with the battery pack.

As a result, a battery pack according to an exemplary embodiment of the present invention can be used as a simplified or abbreviated version of an auxiliary power source, in an environment where a user owns and uses various types of AC power tools for various kinds of work, with the battery pack acting as a simplified or abbreviated version of an auxiliary power source when the user finds it difficult to utilize the commercial power source.

This battery pack also provides an additional effect that the battery pack does not require the user to temporarily use a conventional cordless power tool which outputs power at an unsatisfactory level, for utilization of the commercial power source, meaning that this battery pack provides improved ease-to-use of power tools.

According to another aspect of the invention, an alternative battery pack is provided which is configured to output from an output terminal of the battery pack, instead of an AC voltage, a DC voltage or a voltage having a varying electric property as a function of a signal received from the side of an electric device, which improves power output performance of the electric device. Particularly, when the electric device is one which is principally based on motor load, such as a power tool, the electric device can be synergistically improved by the employment of a high-efficiency motor driven by DC only, or motor rotation control using frequency control, with the cooperation with an ability of the battery pack to increase voltage output.

There will be next described runtime-related effects of the battery pack which is constructed according to each aspect of the invention or other devices.

In a cordless power tool according to an exemplary embodiment of the present invention, the loading current is so remarkably small that energy which is consumed in the form of heat emission is small, in comparison with a conventional cordless power tool, with increased efficiency of power supply from the battery pack to the motor.

Therefore, in a battery pack according to an exemplary embodiment of the present invention, the loading current required to be supplied can be reduced, such that the reduced loading current is smaller than that of a conventional battery pack, by down to the reciprocal of an output voltage ratio between the battery pack according to the invention and the conventional battery pack. That is, in a battery pack according to the invention, the amount of electricity required to be supplied to the motor can be reduced relative to when a conventional battery pack is used for machining the same workpiece.

As a result, in a battery pack according to an exemplary embodiment of the present invention, even if the battery cell capacity is selected to be smaller than that of a conventional battery pack, by down to the reciprocal of the output voltage ratio with the conventional battery pack, the runtime can be long enough to satisfy the user.

In addition, when a required runtime exceeds a runtime which can be provided by a fully-charged battery pack, and subsequent work is needed without interruption, electrical connection of a cordless power tool according to an exemplary embodiment of the present invention with an electrical cord adaptor according to an exemplary embodiment of the present invention would enable continuous work, with the cordless power tool acting as a corded AC power tool. Because the AC motor, which is powered by electricity which is directly supplied from the commercial power source, is used, a whole AC-DC converter in a conventional system can be eliminated, which solves a problem with respect to an AC-DC converter.

There will be next described weight-related effects of a battery pack which is constructed according to each aspect of the invention and other devices.

Even if a cordless power tool according to an exemplary embodiment of the present invention, is used with a battery pack having an electricity capacity smaller than that of a battery pack used with a conventional cordless power tool, the output power and the runtime of the battery pack will satisfy a user. The weight of the battery pack principally depends on the total amount of electricity of a battery cell group disposed within the battery pack. Therefore, a battery pack according to an exemplary embodiment of the present invention would also provide a weight reduction effect that allows the battery pack to be light-weighted enough to satisfy a user.

There will be next described initial-cost-related effects of a battery pack which is constructed according to each aspect of the invention or the other devices.

Even if a cordless power tool according to an exemplary embodiment of the present invention, is used with a battery pack having an electricity capacity smaller than that of a battery pack used with a conventional cordless power tool, the output power, the runtime and the weight of the battery pack will satisfy a user. The initial cost of the battery pack principally depends on the cost of a battery cell group disposed within the battery pack, which principally depends on the total electricity capacity of the battery cell group.

Therefore, a cordless power tool system according to an exemplary embodiment of the present invention would provide an effect that the battery pack can have a total electricity capacity smaller than that of a battery pack for use in a conventional cordless power tool system, while providing improved output and improved runtime. This cordless power tool system would further provide an additional effect that this system can contribute to initial cost reduction, because a charger is not needed for charging the battery pack, and the same electrical cord adaptor can be used both for charging of the battery pack and for supplying of power to the cordless power tool.

There will be next described running-cost-related effects of a battery pack which is constructed according to each aspect of the invention, or the other devices.

A cordless power tool according to an exemplary embodiment of the present invention, can be used with a battery pack having an electricity capacity smaller than that of a battery pack used with a conventional cordless power tool, and therefore, the amount of electricity which needs to be supplied from the commercial power source to the battery pack can be relatively small. In addition, because of a reduction in the loading current of the battery pack, progress of aging such as electrode corrosion in battery cells is suppressed without using any complex charge control technique or the like, resulting in the extended life time of the battery pack.

As a result, a cordless power tool system according to an exemplary embodiment of the present invention, provides an effect that the cost for using the commercial power source is reduced because of a reduced amount of electricity supplied from the commercial power source, and an additional effect that the running cost is reduced because a replacement cycle in which a used battery pack is replaced with a new battery pack is elongated owing to the extended life time of the battery pack.

There will be next described effects of a battery pack which is constructed according to each aspect of the invention, or the other devices, with respect to electrical isolation or separation in the battery pack.

A battery pack according to an exemplary embodiment of the present invention has a connect/disconnect device between battery cells within a battery cell group, and the connect/disconnect device permits the current flow when discharge control circuitry is in an output state. On the other hand, when the discharge control circuitry is not in an output state, the battery cells within the battery cell group are allowed to be electrically insulated from each other or one another, by the connect/disconnect device, and the battery cell group is electrically divided into a plurality of sub-group of battery cells, with each sub-group having a smaller number of battery cells than the total number of the battery cells within the battery pack.

Therefore, a voltage impressed to space between battery cells having mutually different voltages within the battery pack, a voltage impressed to space between voltage monitor wires within the battery pack, and a voltage impressed to space between the voltage monitor wires and the battery cells within the battery pack, are lower than that of the commercial power source voltage, which prevents higher voltages from being impressed to every one of those segments for a longer time.

For example, when a battery cell group is in the form of serial connection of twenty-seven (27) Li-ion battery cells each of which has a voltage of 4 volts just after fully charged, if a conventional technology is employed, then a maximum voltage of 108 volts is very often impressed to every one of the above-described segments.

However, in one implementation of the present invention, the connect/disconnect devices are disposed for each group of every nine (9) battery cells which are serially interconnected, and therefore, the connect/disconnect devices electrically insulate the sub-groups of the battery cells from one another, with an impressed voltage up to 36 volts to every one of the above-described segments. As a result, this prevents a maximum voltage of 108 volts from being very often impressed to every one of the above-described segments, with improved reliability in the electrical insulation.

In addition, if, in a conventional battery pack in which a maximum voltage of 108 volts is constantly impressed, electrically-conductive foreign matters such as metallic debris or water enter the battery pack from outside, then a short-circuit in which a portion of the 108 volts acts as a virtual power source is formed within the battery pack, which causes dielectric breakdown.

Additionally, if the electrically-conductive foreign matters enter the interior of a battery pack and is attached to the exterior of the battery pack, an electrical leakage circuit in which the portion of 108 volts acts as a virtual power source is formed with current flowing from the interior to the exterior of the battery pack, which causes electric shock. Notably, the electrically-conductive foreign matters are introduced from the exterior into the interior of the battery pack with ease, when the battery pack is kept unused with the battery pack unattached to a cordless power tool, that is, when one of faces surrounding the battery pack in which a terminal of the battery pack is disposed, is kept exposed to an ambient atmosphere.

In a battery pack according to an exemplary embodiment of the present invention, for example, when the battery pack is in a non-use state in which the battery pack is unattached to the cordless power tool and is not allowed to output, battery cells within a battery cell group are electrically insulated from each other or one another, with a maximum possible voltage of 36 volts impressed to every one of the above-described segments.

As a result, even if the short-circuit or the electrical leakage circuit as described above is formed due to introduction of electrically-conductive foreign matters, this battery pack would provide drastically suppress progress of the electric breakdown and reduce the maximum level of an impressed voltage to be so low that, reportedly, a human body cannot really perceive electricity, resulting in prevention of electric shock. This contributes to simplification of the interior structure of the battery pack and improved reliability in the electrical insulation.

In addition, a battery pack according to an exemplary embodiment of the present invention has battery modules each of which accommodates a battery cell group which is composed of battery cells having the number smaller than the total number of the battery cells within the battery pack. The battery cell group of each battery module is housed within a casing made of an electrically-insulating material, and therefore, each battery cell group is disposed to as to be electrically insulated from one or more other battery cell groups within one or more other battery modules.

In a conventional technology, for example, if a battery cell group is in the form of serial connection of twenty-seven (27) Li-ion battery cells each of which has a voltage of 4 volts just after fully charged, twenty-seven (27) voltage monitor wires for detecting a voltage of each battery cell are required excepting the ground lines. These voltage monitor wires have, for example, two voltage monitor wires for detecting voltages of two of the battery cells located at a positive polarity end and a negative polarity end of the battery cell group, to which a voltage worth twenty-six (26) battery cells between these two voltage monitor lines, that is, a voltage of as high as 104 volts if just after fully charged.

Within the battery pack, the two voltage monitor wires are required to space apart by a distance for ensuring the reliability in the electrical insulation between the two voltage monitor wires and between the two voltage monitor wires and each of the battery cells. For this reason, there is a need for ensuring an adequate isolation distance in all combinations of the twenty-seven (27) voltage monitor wires and the twenty-seven (27) battery cells which are disposed within the battery pack, leading to the complexity of the interior structure of the battery pack.

In a battery pack according to an exemplary embodiment of the present invention, for example, the above-described twenty-seven (27) battery cells is divided into three groups each of which has nine (9) battery cells to be housed within each module casing, and the battery cell group within each battery module is electrically insulated from other battery cell groups within other battery modules. In addition, a maximum possible voltage which can be impressed between the battery monitor wires which are disposed within each battery module is up to a voltage worth nine (9) battery cells.

Therefore, because a voltage impressed to space between battery cells having mutually different voltages within each battery module, a voltage impressed to space between the voltage monitor wires, and a voltage impressed to space between the voltage monitor wires and the battery cells, are lower than that of the commercial power source voltage, the above-described adjacent segments are not required to be space apart by a long isolation distance having a required length under the voltage of the commercial power source. This contributes to simplification of the interior structure of the battery modules.

There is a conventional approach to detect a state of battery cells within each battery module and disable or block input/output operation of each battery module. In this approach, even if one of the battery modules disables its own input/output operation (i.e., an electrical conduction state), one or more other battery modules within the same battery pack are held in an electrical conduction state. As a result, a high voltage of the battery module group which is held in a serial connection state is impressed to an area in which some of the battery modules, wherein the some battery modules are held in an electrical conduction, are electrically interconnected in series, resulting in the poor reliability in electrical insulation.

Then, a battery pack according to an exemplary embodiment of the present invention is constructed to include: a main controller having discharge control circuitry; battery modules; and a transmit/receive device configured to transmit/receive a signal indicating that input/output operation of the main controller or the battery modules is enabled or disabled, in a selected one of a bi-direction between the main controller and the battery modules, a direction from the main controller to the one or more battery modules, and a bi-direction between each of the battery modules and other battery modules within the battery pack, when the main controller or the battery modules attempt to enable or disable the input/output operation.

This prevents the battery modules each placed in an electrical conduction state, from being continually serially interconnected, when there is no need for input/output operation in the battery pack. Therefore, this allows detection of the state of the battery cells disposed within the battery modules, without complicating the electrical wiring, while allowing the reliability in the electrical insulation to be improved, which contributes to simplification of the interior structure of the battery pack.

Each battery module stored in this battery pack has a casing made of an electrically-insulating material, in which the battery cell group and the battery module control circuitry are housed. The casing is exposed to the outside only at its input/output terminal at which the main controller is connected with each battery module. This prevents any foreign matters from entering each battery module from the outside. Therefore, it is easier to provide electrical isolation between the battery cells of the battery cell group in each battery module, or the like, wherein the battery cells of the battery cell group have mutually different voltages. This is conductive to simplification of the interior structure of the battery modules.

There is a conventional battery pack configured to include circuitry for disabling a current flow through an input/output terminal for the purpose of overdischarging, when the amount of charge of battery cells within the battery pack has been zeroed. This conventional battery pack is held in an electrical conduction state, while the amount of charge of the battery cells are not zeroed.

For example, if a battery pack is designed using a conventional technology, in which twenty-seven (27) Li-ion battery cells are serially interconnected, for the purpose of supplying an output power at a level which is comparable to that of the commercial power source, then each battery cell, just after fully charged, has 4 volts, that is, the battery cell group has 108 volts. For example, if the battery pack is left unused or unattended for half a year after the battery pack has been fully charged as described above, then a maximum voltage of 108 volts or near will be continuously impressed to each segment within the battery pack and an input/output terminal during the same duration, while a small amount of a voltage drop results from self-discharge of the battery cells and self-consumption of power of a circuit in the battery pack. This causes problems such as isolation degradation and electrical leakage due to introduction of foreign matters.

Then, according to an exemplary embodiment of the present invention, a battery pack is provided, including a plurality of battery modules each of which has an input/output terminal, the battery pack comprising;

circuitry for measuring a length of a non-use time during which the battery pack is kept unused for electrical purpose; and

circuitry for disabling a current flow through the input/output terminal of each battery module, if the measured non-use time exceeds a predetermined length of time.

This battery pack would prevent long-term high voltage impression to each segment within the battery pack and between a pair of points opposite in polarity of each input/output terminal, with improved reliability in electrical insulation. In addition, even if current flow through the input/output terminal of each battery module is enabled where the discharge is needed, the voltage impressed between the pair of points of the input/output terminal of each battery module is lower than that of the commercial power source voltage. Therefore, this eliminates a need for leaving between polarity-opposite points an isolation distance having a required length under the voltage of the commercial power source, which contributes to simplification of the interior structure of the battery pack.

In addition, according to an exemplary embodiment of the present invention, a battery pack is provided, wherein the battery pack includes a plurality of battery modules each of which has an input/output terminal, and a discharge output terminal in common to the plurality of battery modules,

the battery pack comprising:

a detector configured to determining whether the discharge output terminal is connected with an outlet plug of an electric device; and

circuitry for disabling output operation of at least one of the input/output terminal and the discharge output terminal, if the outlet plug of the electric device has not been electrically connected with the discharge output terminal, or if the battery pack has been unused for a predetermined length of time or more, for electrical purpose, with the outlet plug of the electric device connected with the discharge output terminal.

If this battery pack disables the output operation, where the outlet plug has not been electrically connected with the discharge output terminal, the electrical device remains unused with the outlet plug connected with the outlet terminals, then a tracking phenomenon which is caused by long-term impression of voltage between polarity-opposite points of each terminal is prevented. In addition, the use of an outlet cover which moves integrally with the detector would provide a user with visual perception of safety.

There will be next described effects of a battery pack which is constructed according to each aspect of the invention or the other devices, with respect to duplicate protection during charge.

A module controller which is housed in a battery module within a battery pack according to an exemplary embodiment of the present invention has a detector configured to detect a state of battery cells within the battery module, and has a charge interruption device configured to interrupt a charging path within the battery module, if a determination is made that it is in a state in which the battery cells are not permitted to be charged.

A main controller having charge control circuitry has a detector configured to detect a state of the battery modules through input-output terminals of the battery modules, and has a charge interruption device configured to interrupt a charging path between the charge input terminals and the battery module group is interrupted, if a determination is made that it is in a state in which the battery modules are not permitted to be charged.

In addition, the main controller and each module controller may be implemented in a mode in which there is a selected one of circuitry for transmitting and receiving a signal indicating that charging is disabled, in a bi-direction between the main controller and each module controller, circuitry for transmitting and receiving a signal indicating that charging is disabled, in a direction from the main controller to each module controller, and circuitry for transmitting and receiving a signal indicating that charging is disabled, in a bi-direction between each module controller and one or more other module controllers of one or more other battery modules within the battery pack.

This mode has a charge interruption device which is configured, such that, when the main controller has interrupted charging of the battery pack, each module controller

detects a state in which the main controller has interrupted the charging, in response to reception of the signal from the main controller, indicating that the charging is disabled, and

interrupts a charging path within the each battery module,

and instead, when one of the module controllers has interrupted the charging, the main controller or one or more module controllers within one or more other battery modules

detect a state in which the each module controller has interrupted the charging, in response to reception of the signal from the each module controller, indicating that the charging is disabled, and.

interrupt a charging path between a charge input terminal and the battery module group.

In a battery pack according to an exemplary embodiment of the present invention, a plurality of battery modules are electrically interconnected in series, and therefore, even if it is brought into a failure in which the charge of at least one of the battery modules cannot be interrupted, the charge of the remaining battery modules can be interrupted, because of the use of any one of the aforementioned charge interruption devices.

Accordingly, when the battery pack, for being charged, is connected directly to the commercial power source which cannot be controlled by the user, even if any one of segments within the battery pack, which perform the charge interruption, that is, one unit of the main controller and the plurality of battery modules, is brought into a state in which the charge of any one of the segments cannot be interrupted, the remaining segments can interrupt of the charge, which provides reliability higher than duplicate protection.

Several presently preferred embodiments of the invention will be described in more detail by reference to the drawings in which like numerals are used to indicate like elements throughout.

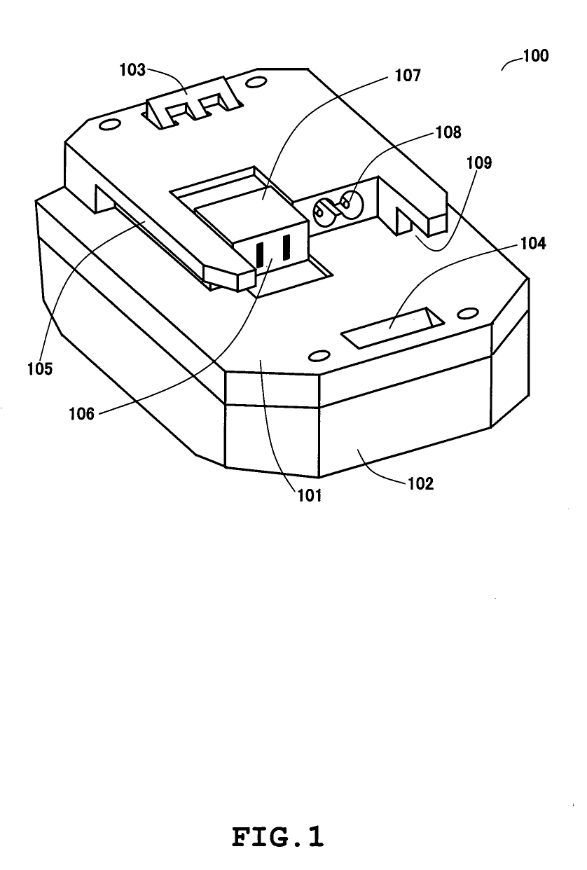

With reference to FIGS. 1-12, a cordless power tool combined with a battery pack according to a first embodiment of the present invention will be next described.

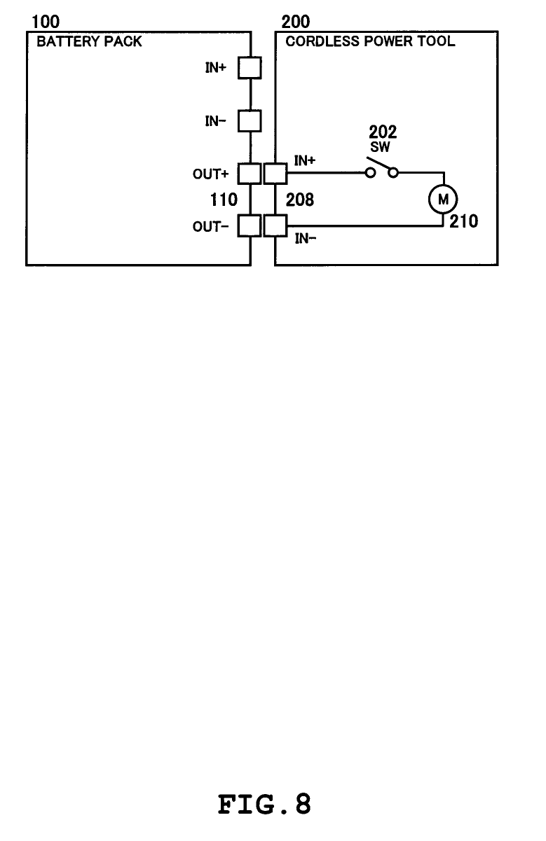

FIGS. 1-7 schematically illustrate the construction of a system (a power tool unit) using a cordless power tool, while FIGS. 8-12 schematically illustrate in functional block diagram how to use the system using the cordless power tool system.

FIG. 1 illustrates the exterior of a battery pack 100 for use in the cordless power tool system. The battery pack 100 contains inner constituent components all of which are enclosed with an upper case 101 and a lower case 102 both of which are made of electrically-insulating material.

The upper case 101 includes a movable hook-button 103; an engagement recess 104; slide rails 105; an outlet 106 for discharging which is identical in shape to the outlet of the commercial or common power source; a movable outlet cover 107 made of electrically-insulating material; and an inlet 108 for charging which has the same insertion direction as the outlet 106. Further, guide recesses 109 are disposed at the front ends of the slide rails 105.

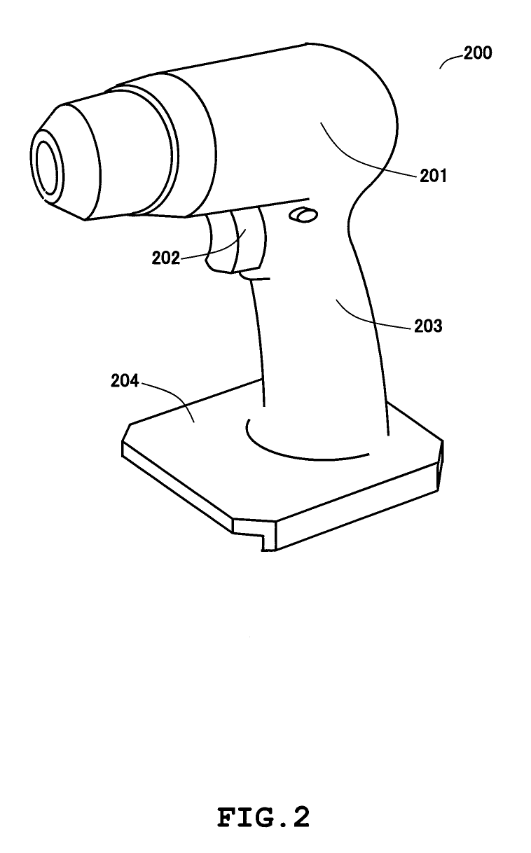

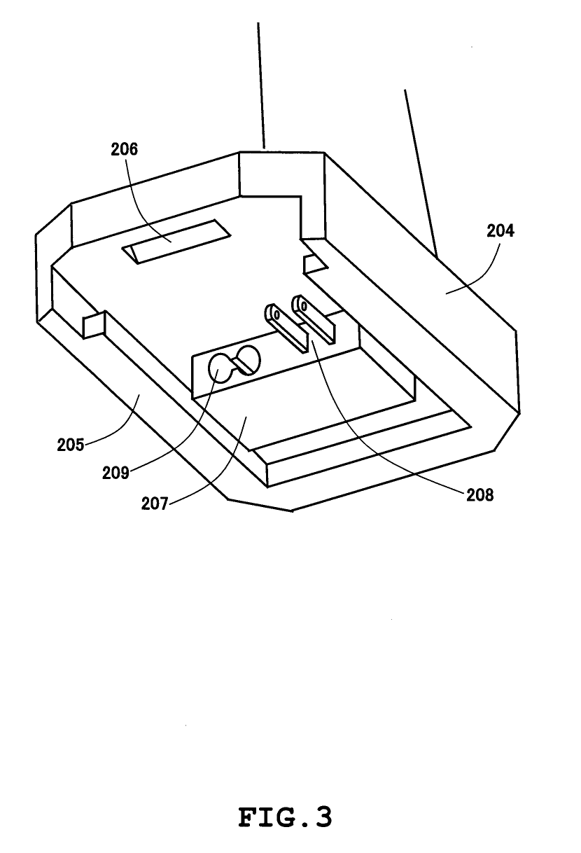

FIG. 2 illustrates the exterior of a cordless power tool 200 which is a part of the cordless power tool system. In addition, FIG. 3 illustrates the exterior of the bottom of the cordless power tool 200. The cordless power tool 200 has a motor housing 201 which houses an AC motor adapted to be powered by the commercial power source; a switch 202 for control of the AC motor; a handle 203; and a battery pack retainer 204 for connection with the battery pack 100.

The battery pack retainer 204 has guide rails 205 extending along the slide rails 105 of the battery pack 100, an engagement recess 206 extending along the hook-button 103 of the battery pack 100, and a terminal block 207 made of electrically-insulating material. The terminal block 207 includes a power-input terminal 208 and a dummy recess 209. The power-input terminal 208 is identical in shape to the terminal of the outlet plug for the commercial power source and supply electricity to the motor. The dummy recess 209 has no terminal for electrical connection.

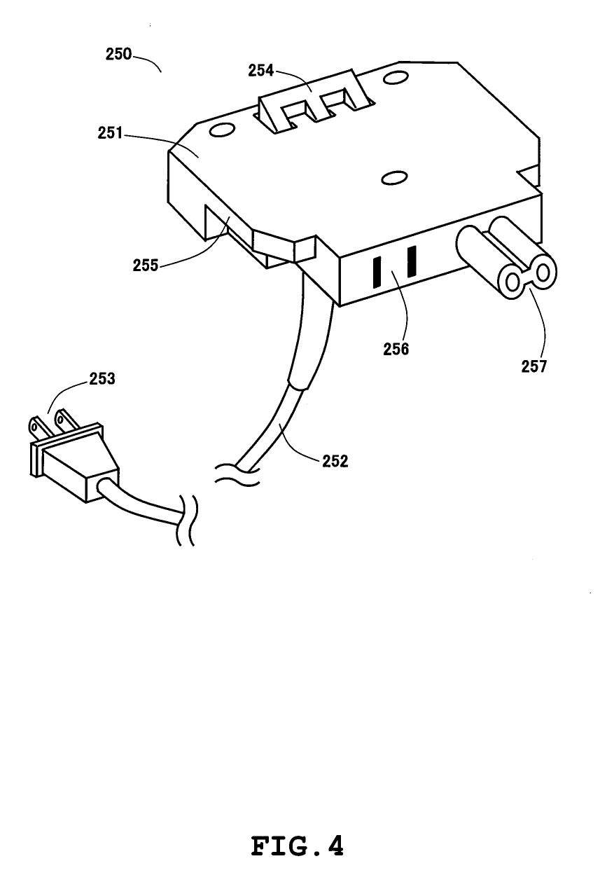

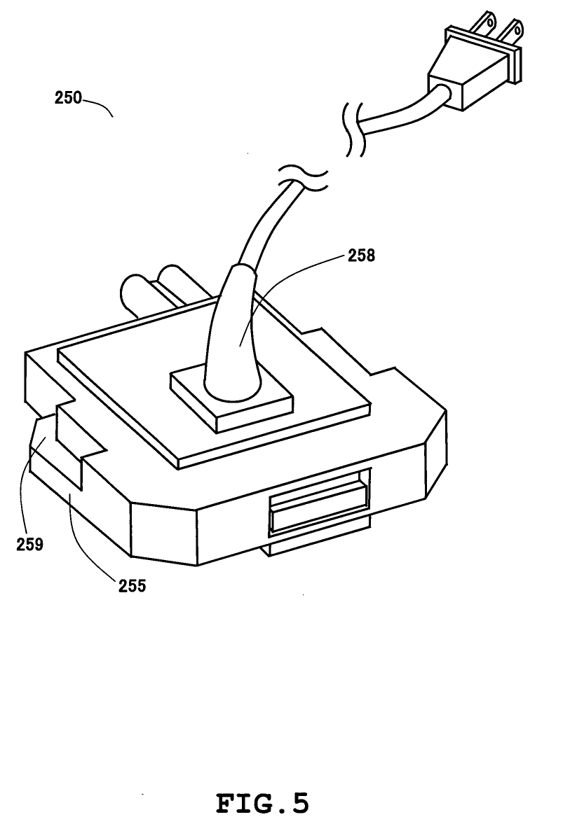

FIG. 4 illustrates the exterior of an electrical cord adaptor 250 for use in the cordless power tool system. In addition, FIG. 5 illustrates the exterior of the bottom of the electrical cord adaptor 250 illustrated in FIG. 4.

The electrical cord adaptor 250 is constructed to primarily include a case 251 made of electrically-insulating material; an electrical cord 252; an outlet plug 253 which is located at a front end of the electrical cord 252; a hook-button 254 extending along the engagement recess 206 of the cordless power tool 200; slide rails 255; a power-supply terminal 256 for discharging; and a power-supply terminal 257 for charging. The power-supply terminal 257 is adapted to be inserted into and along the inlet 108 of the battery pack 100 and the dummy recess 209 of the cordless power tool 200.

A cord guard 258 covers a connection between the electrical cord 252 and the electrical cord adaptor 250. In addition, front ends 259 of the slide rails 255 are adapted to be inserted into the guide recesses 109 of the battery pack 100.

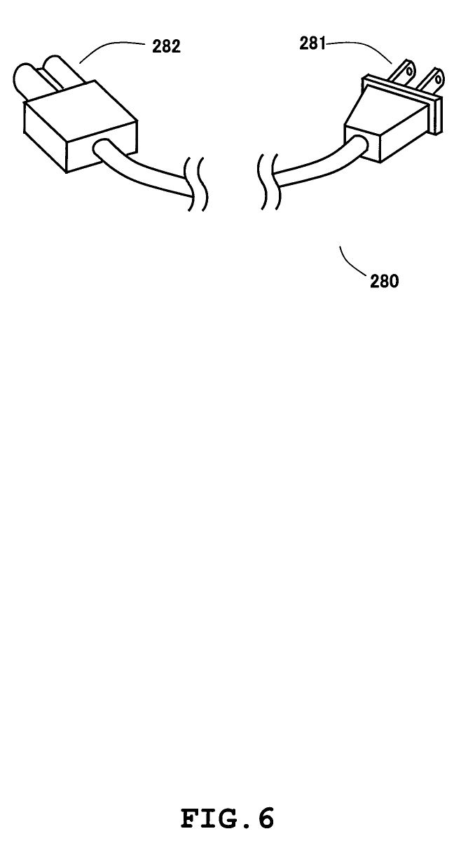

FIG. 6 illustrates the exterior of an electrical cord 280 for charging the battery pack 100 for use in the cordless power tool system.

At both ends of the electrical cord 280, there are an outlet plug 281 and a power-supply terminal 282 for charging. Particularly, the power-supply terminal 282 is identical in shape to the power-supply terminal 257 of the electrical cord adaptor 250 and can be inserted into and along the inlet 108 of the battery pack 100.

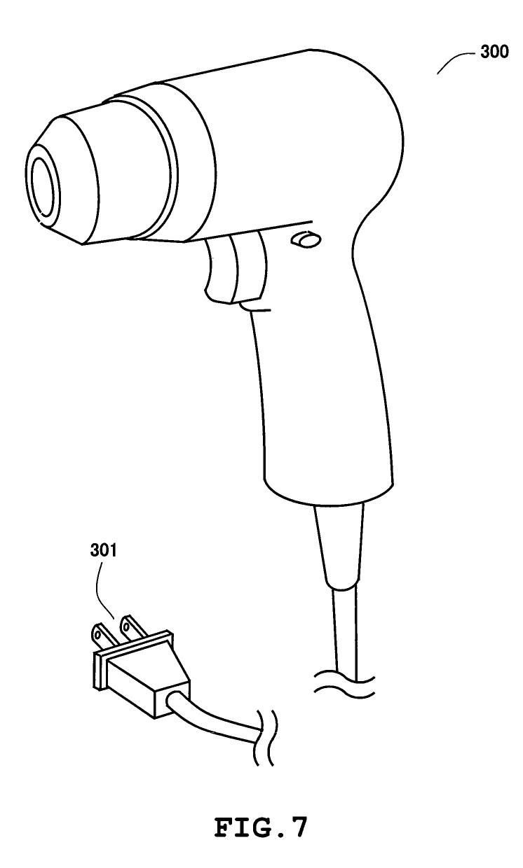

FIG. 7 illustrates the exterior of a conventional AC power tool 300. The AC power tool 300 has an outlet plug 301 for input of AC voltage from the commercial power source.

FIG. 8 illustrates in functional block diagram, the battery pack 100 according to an embodiment of the present invention and the cordless power tool 200 d according to an embodiment of the present invention, when connected.

The battery pack 100 outputs AC electricity which substantially achieves the effective value of the commercial power source. In the cordless power tool 200, an AC motor is driven by AC electricity which is supplied from the battery pack 100 and which is then delivered from a terminal 110 for discharging of the battery pack 100, to the AC motor, through the power-input terminal 208 and the switch 202.

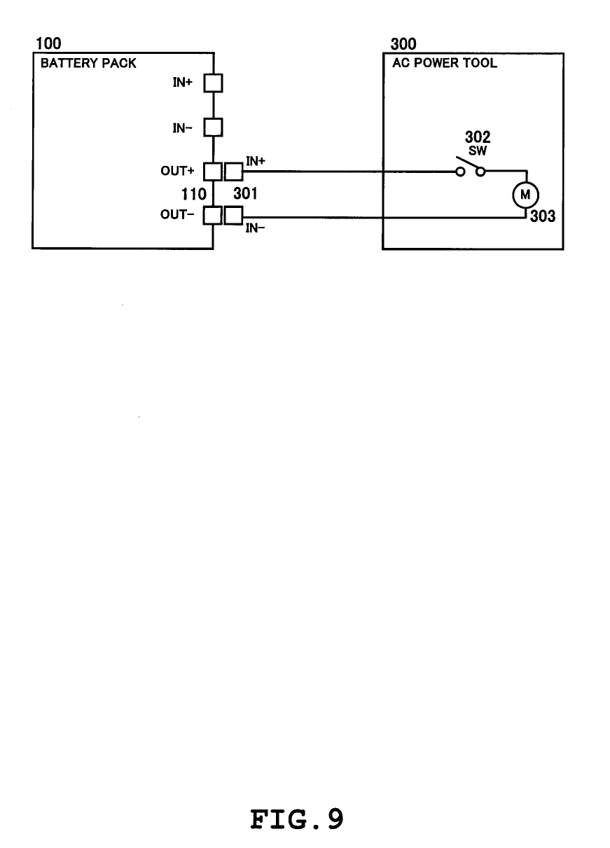

FIG. 9 illustrates in functional block diagram, the battery pack 100 according to an embodiment of the present invention and the conventional AC power tool 300, when connected.

The battery pack 100 outputs AC electricity which substantially achieves the effective value of the commercial power source, through the terminal 110. In the AC power tool 300, an AC motor 303 is driven by AC electricity which is supplied from the battery pack 100 and which is then delivered from the terminal 100 of the battery pack 100 to the AC motor 303, through the outlet plug 301 and a switch 302.

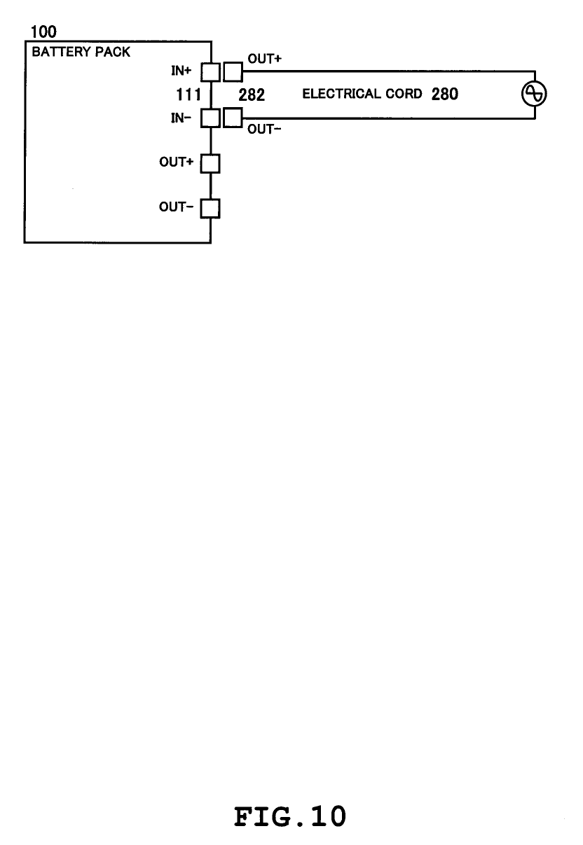

FIG. 10 illustrates in functional block diagram, the battery pack 100 according to an embodiment of the present invention and the electrical cord 280, when connected.

The battery pack 100 is of a type that allows the battery pack 100 to be charged by direct input from the commercial power source without using any charger. Therefore, the battery pack 100 is charged by electricity from the electrical cord 280 which is electrically connected to the commercial power source, to the battery pack 100, through the power-supply terminal 282 and an inlet terminal 111 for charging.

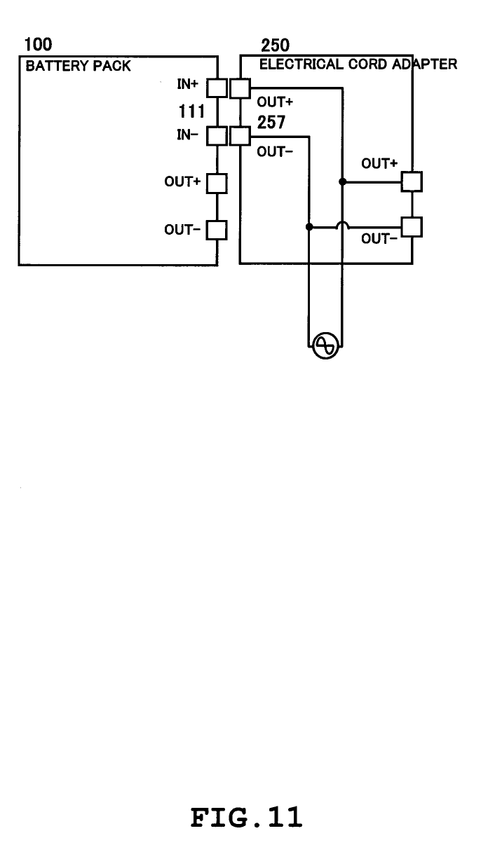

FIG. 11 illustrates in functional block diagram, the battery pack 100 according to an embodiment of the present invention and the electrical cord adaptor 250 according to an embodiment of the present invention, when connected.

The battery pack 100 is of a type that allows the battery pack 100 to be charged by direct input from the commercial power source without using any charger. Therefore, the battery pack 100 is charged with the intervention of the power-supply terminal 257 of the electrical cord adaptor 250 electrically connected to the commercial power source, and the inlet terminal 111.

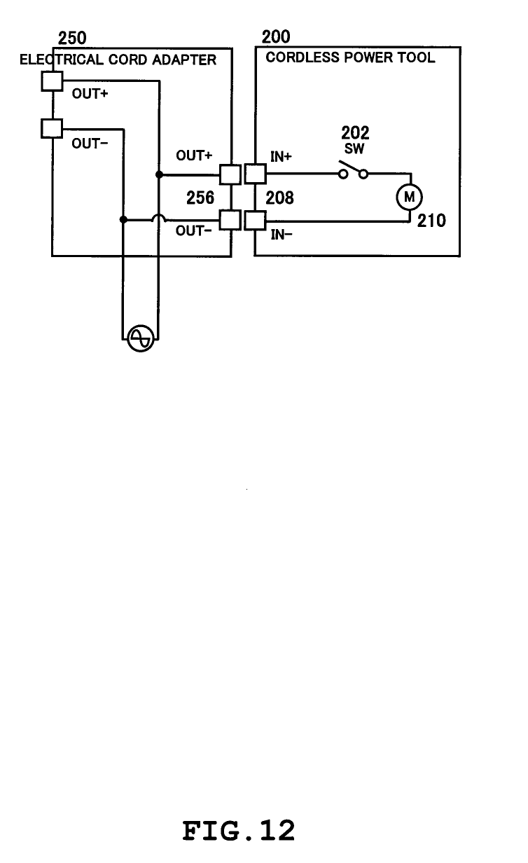

FIG. 12 illustrates in functional block diagram, the electrical cord adaptor 250 according to an embodiment of the present invention and the cordless power tool 200 according to an embodiment of the present invention, when connected.

In the cordless power tool 200, the AC motor 200 is driven by electricity which is supplied from the power-supply terminal 256 of the electrical cord adaptor 250 which is electrically connected to the commercial power source to the AC motor 200, through the power-input terminal 256 and the switch 202.

With reference to the drawings, a cordless power tool system will be next described which is constructed according to an embodiment of the present invention, with respect to its structural arrangement.

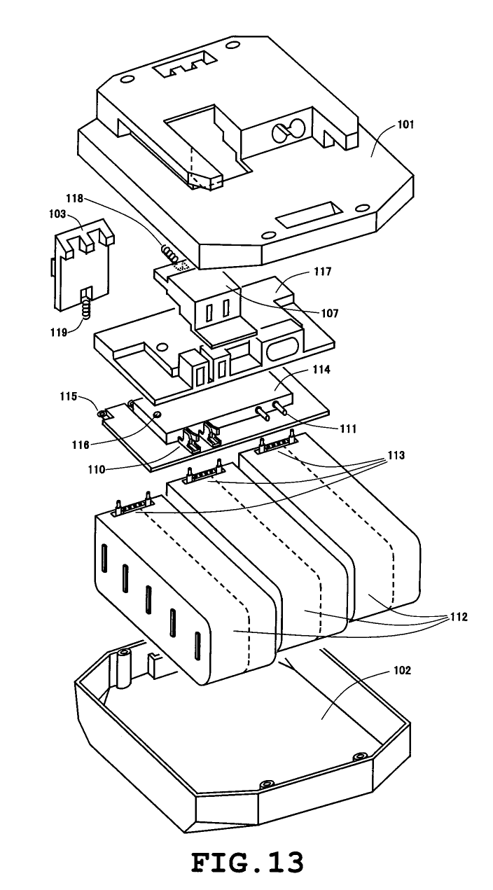

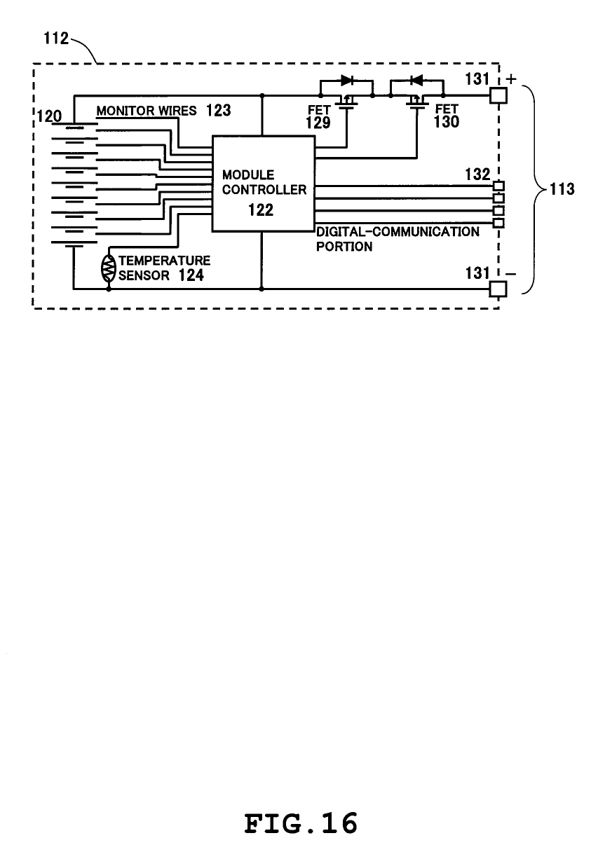

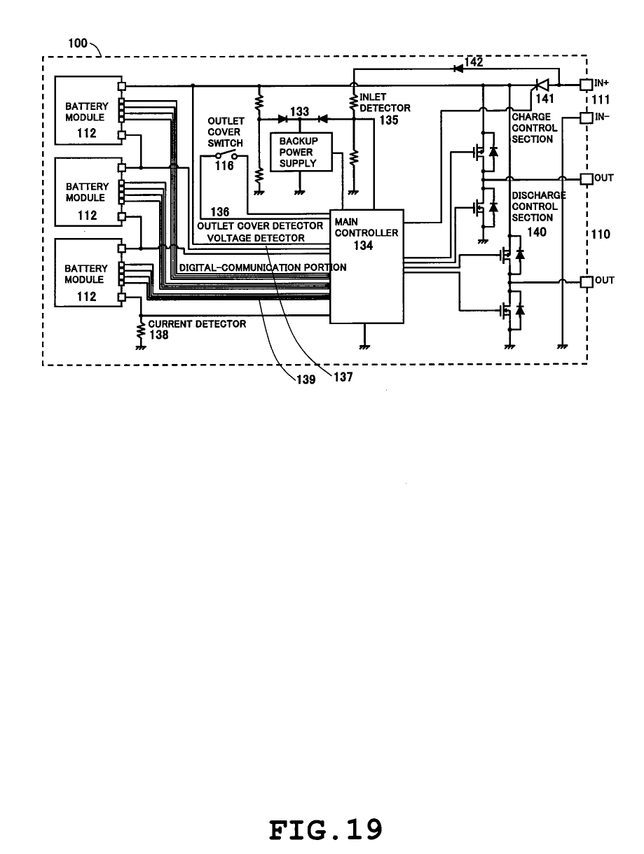

FIGS. 13-15 and 17-18 illustrate the interior structure of the battery pack 100 according to an embodiment of the present invention. FIGS. 16 and 19 illustrate the battery pack 100 according to the first embodiment of the invention in functional block diagram.

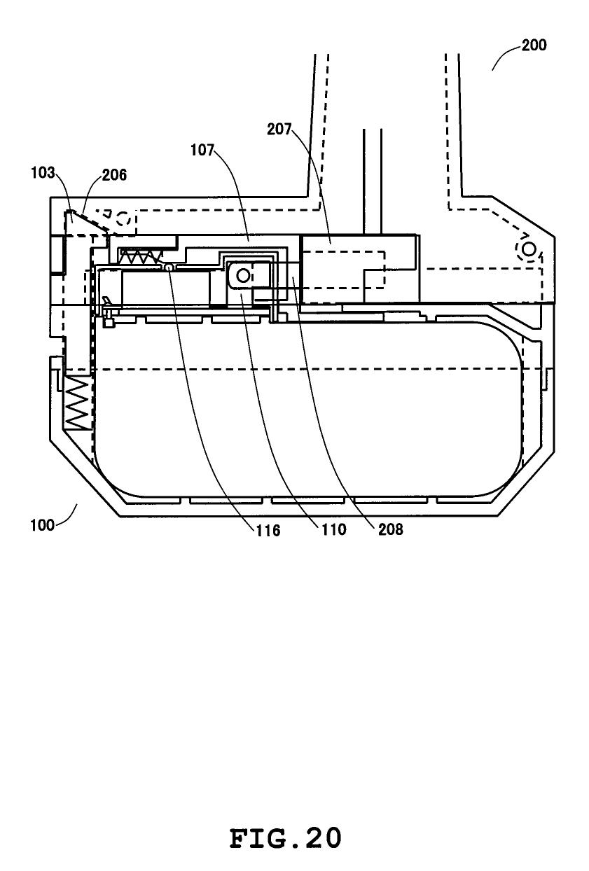

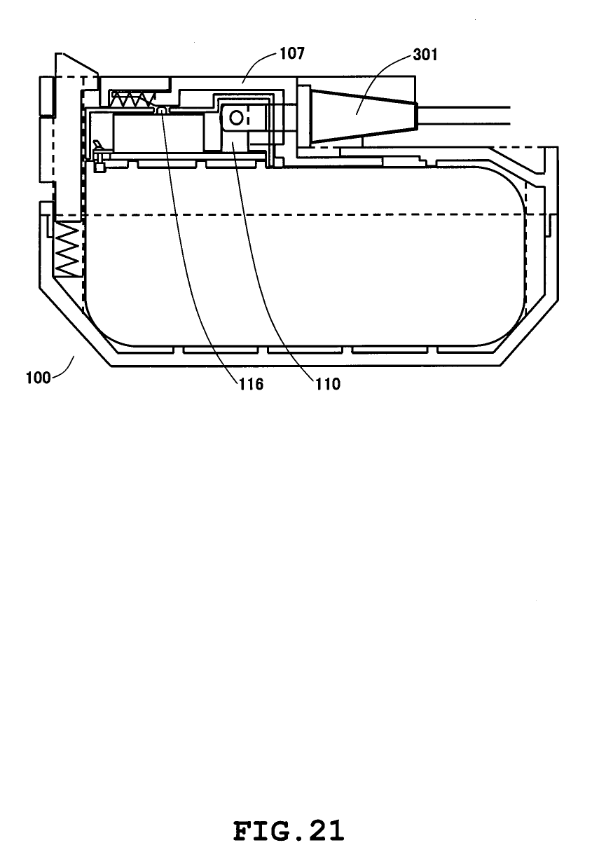

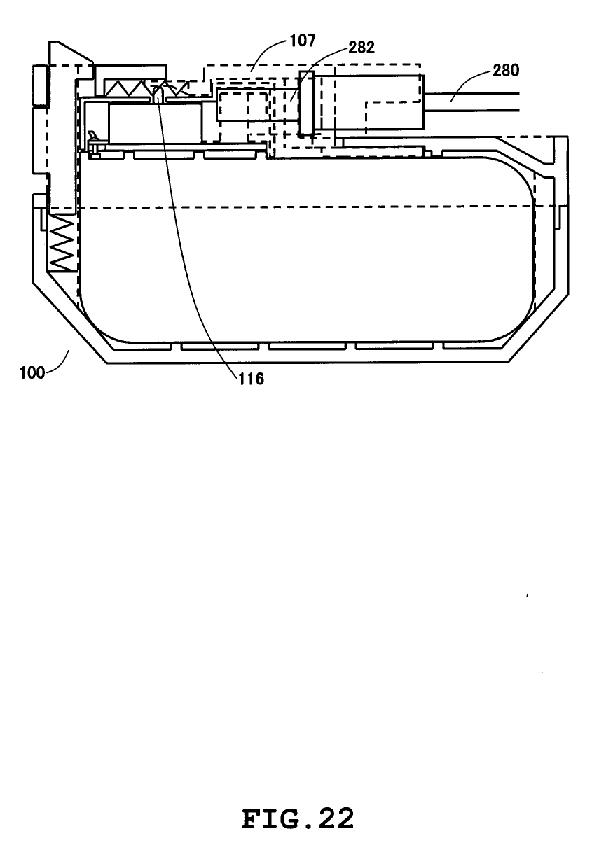

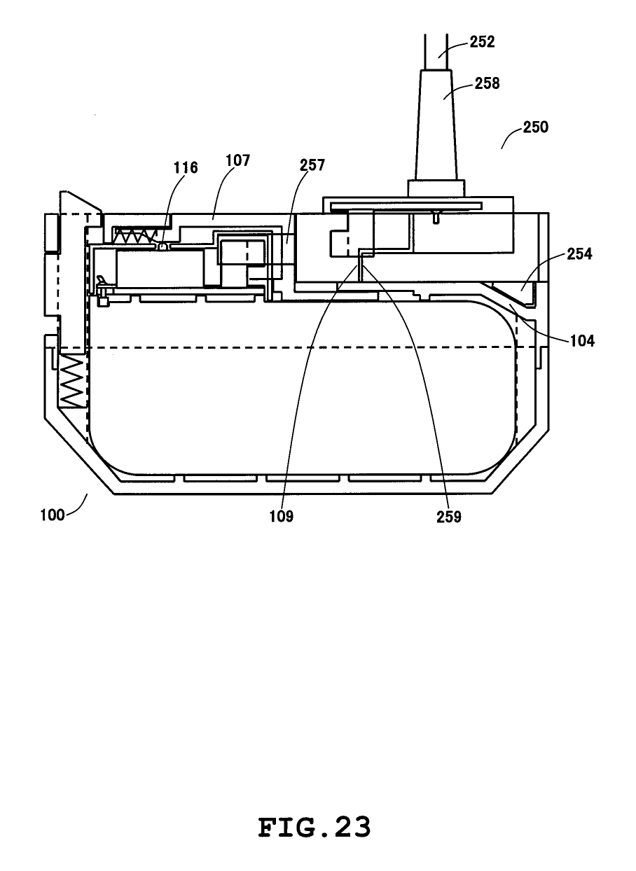

FIG. 20 illustrates the battery pack 100 according to an embodiment of the present invention and the cordless power tool 200 according to an embodiment of the present invention, when connected. FIG. 21 illustrates the battery pack 100 according to an embodiment of the present invention and the outlet plug 301 of the electrical cord of the conventional AC power tool 300, when connected. FIG. 22 illustrates the battery pack 100 according to an embodiment of the present invention and the electrical cord 280, when connected. FIG. 23 illustrates the battery pack 100 according to an embodiment of the present invention and the electrical cord adaptor 250 according to an embodiment of the present invention, when connected.

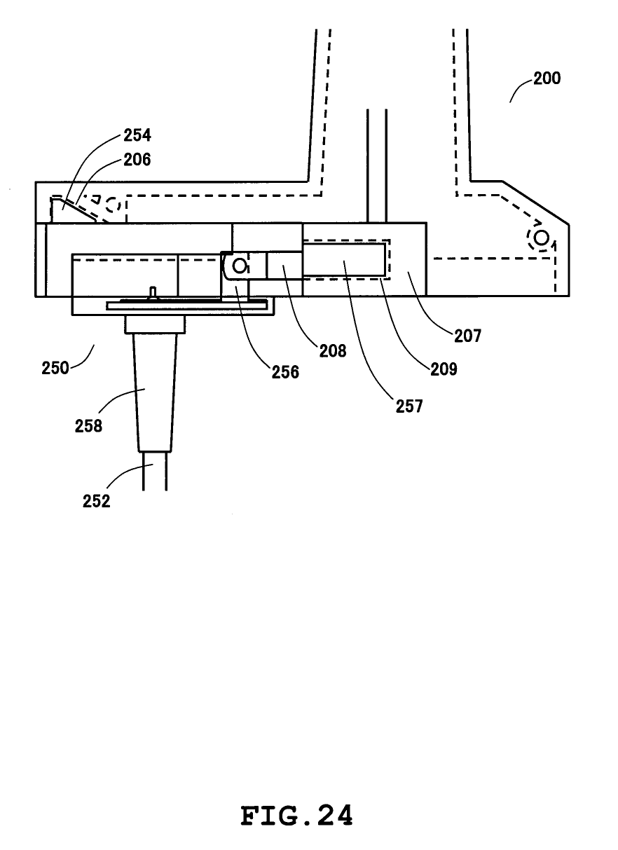

FIG. 24 illustrates the cordless power tool 200 and the electrical cord adaptor 250 both of which are constructed according to an embodiment of the present invention, when connected.

The number of Li-ion battery cells 120 for use in the battery pack 100 according to an embodiment of the present invention is preferably selected so as to allow a DC voltage of a group of serially-connected battery cells to be converted into an AC voltage for output, and allow the AC voltage to have its effective value which is comparable to that of the commercial power source. The battery pack 100 is preferably comprised of two or more battery modules 112. Particularly, the number of the battery cells 120 within the battery module 112 is preferably a selected one of factors or divisors of the total number of the battery cells 120.

It is added that the battery cells 120 are not limited in type to Li-ion batteries but may cover a wide range of alternatives in the form of rechargeable batteries which can generate electric power within the battery pack 100. The battery pack 100 when it uses twenty-seven (27) Li-ion battery cells 120 and three (3) battery modules 112 will be next described as a mode in which the present invention is carried out.

FIG. 13 is an exploded perspective view of the battery pack 100 according to an embodiment of the present invention.

The battery pack 100 according to an embodiment of the present invention houses three (3) battery modules 112; a main controller assembly 114; a controller cover 117 made of electrically insulating material; the hook-button 103 made of electrically insulating material; a spring 119 allowing slide movement of the hook-button 103; the outlet cover 107 made of electrically insulating material; and a spring 118 allowing slide movement of the outlet cover 107. These inner constituent components are enclosed with the upper case 101 and the lower case 102, both of which are made of electrically insulating material.

If the controller cover 117 is formed to have an additional wall which is interposed between both pins of the terminal 110 disposed at the main controller assembly 114, then reliability of electrical insulation will be improved. An additional wall may be provided to the outlet cover 107, which is interposed between both pins of the terminal 110, in slidable contact with both pins.

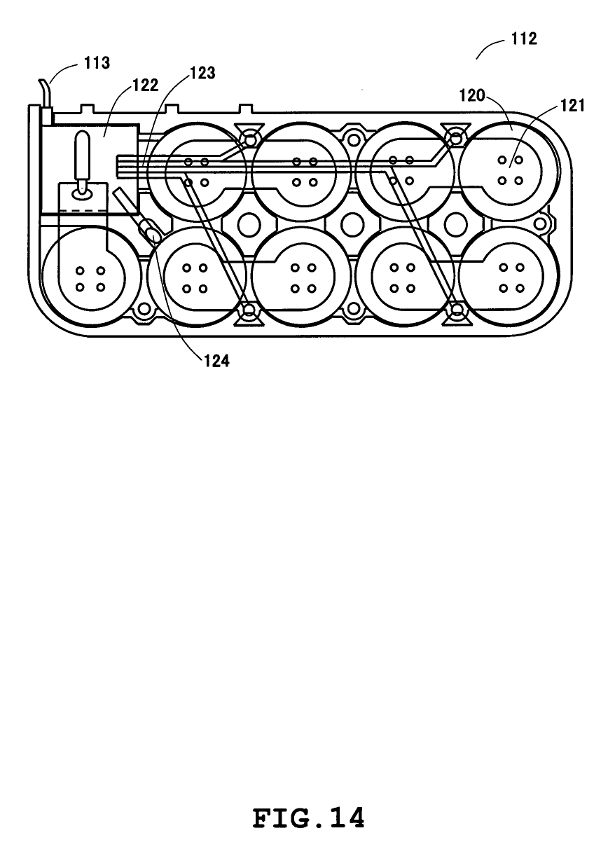

FIG. 14 is a side view illustrating the interior structure of the battery module 112 according to an exemplary embodiment of the present invention. Nine (9) battery cells 120 are electrically interconnected in series into a battery cell group with lead plates 121 attached thereto by spot-welding or the like.

Particularly, the voltage of the battery cell group is preferably selected for a Li-ion battery cell 120, such that the nominal voltage of the battery module 112 is 36 volts in the form of a serial connection of ten (10) or fewer battery cells 120 each having a nominal voltage of 3.6 volts, or such that a maximum voltage of the battery module 112 when fully charged is equal to or lower than 42 volts because each individual Li-ion battery cell 120 has, in general, a maximum voltage of 4.2 volts when fully charged.

This prevents every section within the battery module from having an electrical potential above 42 volts which, reportedly, can cause electric shock to a human body, resulting in the contribution to the improved safety when the battery module is being manufactured.

For example, if each battery module 112 is made to have a nominal voltage of 24 volts, serial connection of two (2) battery modules 112 allows the battery pack 100 to have a nominal voltage of 48 volts. Alternatively, if each battery module 112 is made to have a nominal voltage of 36 volts, serial connection of two (2) battery modules 112 allows the battery pack 100 to have a nominal voltage of 72 volts. Still alternatively, if each battery module 112 is made to have a nominal voltage of 42 volts, serial connection of two (2) battery modules 112 allows the battery pack 100 to have a nominal voltage of 84 volts.

Therefore, this battery pack 100 would provide very high output voltage of 48 volts or more in nominal voltage, which satisfies needs for high power output, while ensuring reliability in the electrical insulation and suppressing cost up using common parts, relative to a conventional battery pack having a maximum voltage of 36 volts.

It is added that, although a plurality of battery modules 112 within the battery pack 100 preferably have the same nominal voltages, which is conducive to promotion of use of common parts, the present invention can be alternatively implemented such that the plurality of battery modules 112 have so different nominal voltages as to achieve a total level of high voltages desired by the user, for the battery pack 100 to produce the desired total level of high voltage.

In this regard, the “voltage of a battery module” refers to a voltage of a selected one of sub-groups of battery cells into which a group of a plurality of battery cells are divided at a location at which battery cells in the battery cell group within the battery pack 100 are electrically isolated or disconnected from each other and is not defined by the mechanical structure of each battery module 112.

In the present embodiment, voltage monitor wires 123 for detecting the voltages of the battery cells 120 is electrically connected at its one end with the lead plates 121 and connected at its other end with a module controller 122. A temperature sensor 124 is disposed at a location suitable for detecting the temperatures of the battery cells, and is electrically connected with the module controller 122. For electrical connection between the module controller 122 and the main control assembly 114, each battery module 112 is exposed to the outside only at its battery input/output terminal 113.

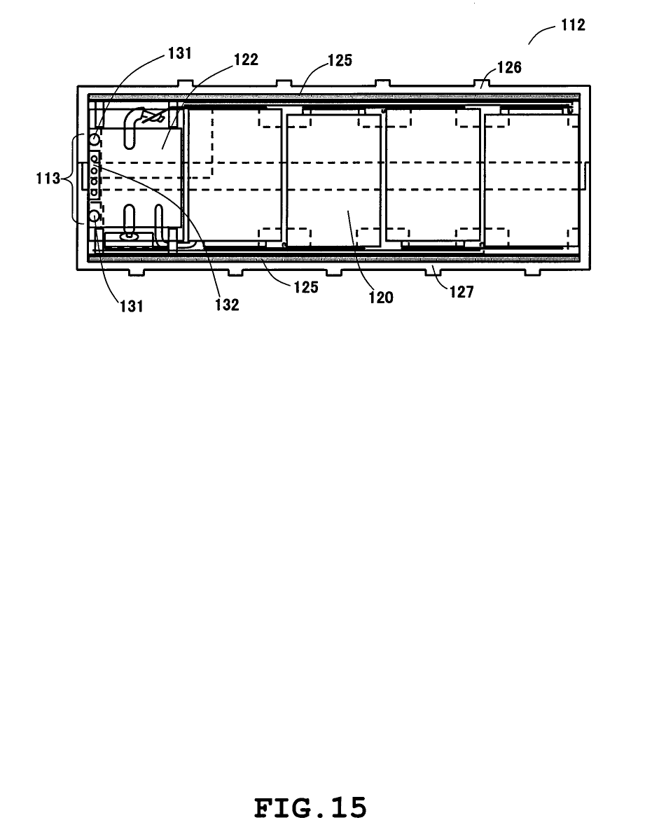

FIG. 15 is a top view illustrating the interior structure of a representing one of the battery modules 112, which is constructed according to an embodiment of the present invention.

Each battery module 112 houses the battery cell group in the form of a serial connection of nine (9) battery cells 120, the voltage monitor wires 123, the temperature sensor 124, and the module controller 122 which is constructed according to the first embodiment of the present invention.

These inner elements are enclosed with a right-hand module case 126 and a left-hand module case 127 each of which is made of electrically-insulating material. The module cases 126, 127 have respective inner walls (illustrated in FIG. 14) extending along the length of the battery cells 120, and have respective portions at which the module cases 126, 127 are coupled to each other, with these portions overlapping with each other.

Cushioning materials 125 illustrated in FIG. 14 in crosshatch, which have electrically insulative and elastic property, are interposed between both ends of the battery cells 120 and the module cases 126, 127.

Alternatively, an outer case of each battery module 112 may be of a type in which a heat-shrinkable laminated sheet is used to enclose those inner elements. The battery input/output terminal 113 is comprised of module input/output portions 131 and a module-controller digital-communication portion 132.

It is added that, in the presence of an undesirable gap between the module cases 126 and 127, the gap is preferably filled with an electrically-insulating filler or sealer by molding.

FIG. 16 is a block diagram illustrating the battery module according to the first embodiment of the present invention. Nine (9) battery cells 120 are electrically interconnected in series and electrically connected with the module input/output portions 131 through an FET 129 for module charge and an FET 130 for module discharge. The module controller 122 is electrically connected with the voltage monitor wires 123 for cell voltage detection and the temperature sensor 124 for cell temperature detection, and performs control using the FETs 129 and 130.

In addition, the module controller 122 has the module-controller digital-communication section 132 and communicates digitally with a main controller 134 described later, through the module-controller digital-communication section 132 and a main-controller digital-communication section 139.

In the present embodiment, the module input/output section 131 constitutes an example of the “input/output terminal” in each of the above-described modes.

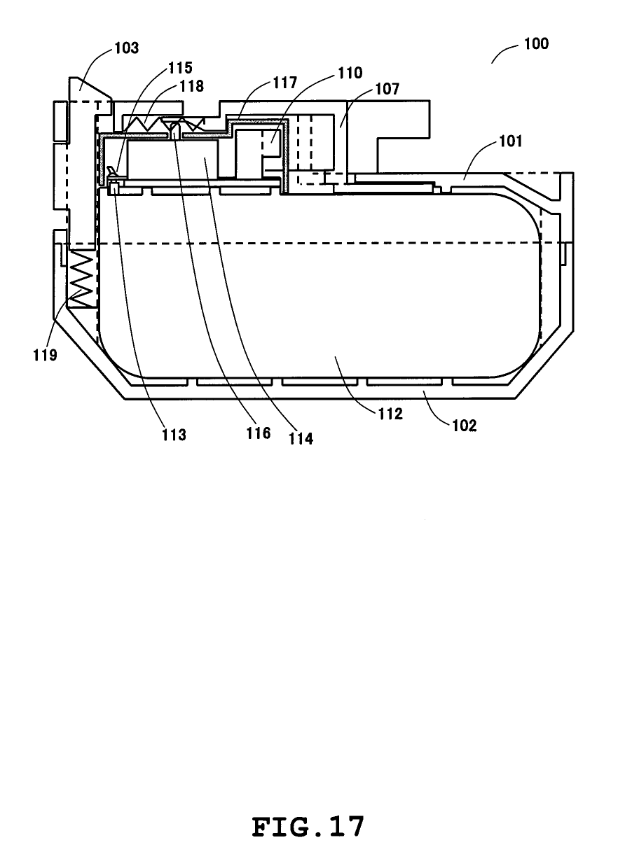

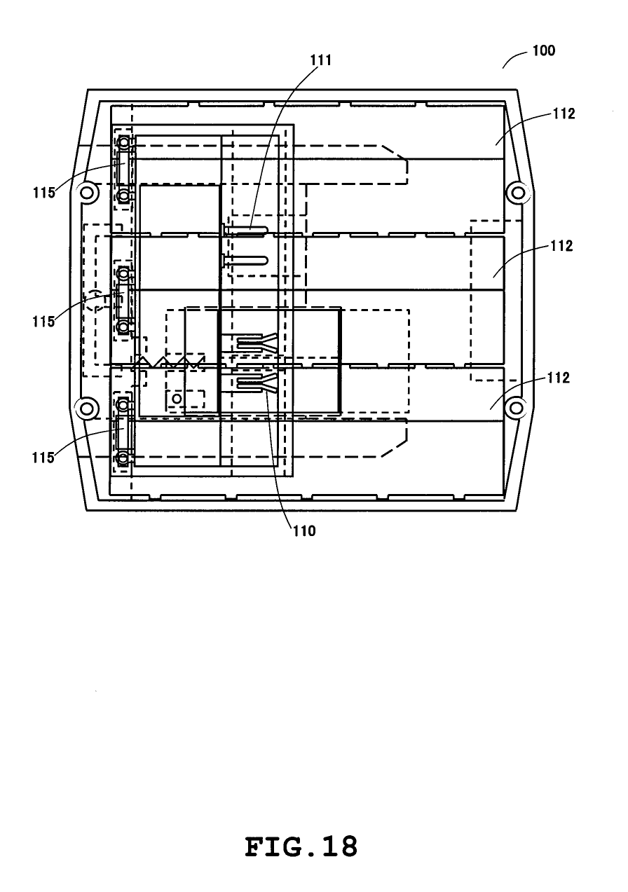

FIG. 17 is a side view illustrating the interior structure of the battery pack 100 according to an embodiment of the present invention, while FIG. 18 is a top view illustrating the interior structure of the battery pack 100 according to an embodiment of the present invention.

The battery input-output terminals 113 of the battery module 112 are electrically connected with terminals 115 (for connection between the main controller 134 and the battery module 112) of the main controller assembly 114. The controller cover 117 illustrated in cross hatch encloses around the main controller assembly 114, so as to leave openings for allowing insertion of the inlet terminal 111 and the terminal 110, and such that one of the surfaces of the main controller assembly 114 which is adjacent to the battery modules 112 is not covered with the controller cover 117.

At the outlet cover 107, the spring 118 is disposed for allowing slide movement of this outlet cover 107, and an outlet cover switch 116 which is attached to the main controller assembly 114 is disposed so as to move integrally with the outlet cover 107. These elements, the hook-button 103 and the spring 119 for allowing slide movement of the hook-button 103 are enclosed with the upper case 101 and the lower case 102 which have respective connections overlapped with each other.

In case the upper case 101 is broken, the controller cover 117 is interposed between the live parts of the main controller assembly 114 and the outside of the battery pack 100, and therefore, the controller cover 117 serves for improvement in the reliability of the electrical insulation between the live parts of the main controller assembly 114 and the outside of the battery pack 100.

As illustrated in FIG. 15, a plurality of electrically-insulating protrusions 310 are formed integrally on two facing ones of six exterior walls forming a module casing 127 (module housing) of each battery module 112. The two facing exterior walls (an upper exterior wall and a lower exterior wall, in the drawing) are oriented in a direction parallel to the axes (hereinafter, referred to as “battery-cell axes”) of the battery cells 120 housed within each battery module 112. A sub-plurality of the plurality of protrusions 310 which are formed on one of these two facing exterior walls are offset from another sub-plurality of the plurality of protrusions 310 which are formed on the other of the two facing exterior walls, in a direction perpendicular to the battery-cell axes.

Therefore, as illustrated in FIG. 18, the protrusions 310 of each battery module 112 are brought into physical contact with a portion of the exterior walls of an adjacent one of the battery modules 112. On the portion, any protrusions 310 are not formed. In this state, the protrusions 310 of each battery modules 112 provide a clearance 312 which extends along the exterior walls, and which is located between the protrusions 310 of the each battery module 112 and the protrusions 310 of the adjacent battery module 112.

As a result, adequate clearance between adjacent ones of the battery modules 112 could serve for effective prevention of heat accumulation in a group of many battery cells in series. That is, in each battery module 112, undesirable heat which can be generated in many battery cells 120 in series can be emitted into the atmosphere via the clearance 312.

Additionally, the movement of the outlet cover 107 allows the user to visually perceive an ON/OFF state of the battery pack 100. In an alternative, a detector is provided for detecting the state of charge of the battery cell 120, and an indicator is also provided for indicating the ON/OFF state to the user, in addition to an original function of displaying the state of charge.

Li-ion battery cells that have been widely used in electrical appliances include a cylindrical cell having a typical size, that is, a diameter of 18 mm and a height of 65 mm. When the battery pack 100 houses twenty-seven (27) Li-ion battery cells 120, like an embodiment of the present invention, if each battery cell 120 is shaped as the above-described cylindrical cell having a diameter of 18 mm and a height of 65 mm, then the battery pack 100 will become too large and heavy to a power tool user.

Then, in an embodiment of the present invention, the battery pack 100 is provided so as to house twenty-seven (27) Li-ion battery cells 120 each of which has a diameter of 18 mm like the above cylindrical cell, but has a height of, for example, 25 mm.

As illustrated in FIGS. 14, 15, 17 and 18, the battery module 112 houses nine (9) Li-ion battery cells 120 each of which has the above-described size, that is, a diameter of 18 mm and a height of 25 mm, such that the battery cells 120 are arrayed with their ends on the same planes. The battery pack 100 houses three (3) battery modules 112 such that one of the battery modules 112 has the axes of the battery cells 120 which are coincident with the axes of the battery cells 120 within the remaining ones of the battery modules 112.

By cell-by-cell comparison, the battery cells 120 of 25 mm height are smaller in per-unit battery capacity than the above-described battery cells of 65 mm height, because of the dependency on the height difference. By cell-group-by-cell-group comparison, however, one battery cell group having twenty-seven (27) battery cells 120 of 25 mm height are equal in total size and weight to one battery cell group having eight (8) Li-ion battery cells of 65 mm height for use in a 14.4V Li-ion battery pack used in a conventional 14.4V cordless power tool which is considered to be compacted and light-weighed. In addition, one battery cell group having twenty-seven (27) battery cells 120 of 25 mm height are far better in a total output power and a total runtime of a battery pack than one battery cell group having eight (8) Li-ion battery cells of 65 mm height, because, when one battery cell group having twenty-seven (27) battery cells 120 of 25 mm height is employed, entry into higher voltage provides a drastic reduction in a load current and therefore a drastic reduction in electricity loss.

It is added that, for a cylindrical cell of 18 mm diameter and 25 mm height, which has been described above as an example of a Li-ion battery cell, the cylindrical cell can provide the above-stated general effects within a preferable shape range that includes a diameter ranging from 16 mm to 18 mm and a height ranging from 20 mm to 30 mm. The preferable shape range can further include the shape of a non-cylindrical battery cell which has a volume per unit that is equivalent to the specific shape range.

FIG. 19 is a functional block diagram illustrating the battery pack 100 according to the first embodiment of the present invention.

Three (3) battery modules 112 which are electrically interconnected in series are electrically connected with the terminal 110 through a discharge control section 140 having four (4) FETs as principal elements, and are electrically connected with the inlet terminal 111 through a charge control section 141 having one (1) SCR as a principal element.

The main controller 134 is powered by a power supply circuit 133 with battery backup function and is electrically connected with a voltage detector 137 for battery module voltage detection, a current detector 138 for charging/discharging current detection, an outlet cover detector 136 for detecting movement of the outlet cover 107, and an inlet detector 135 for detecting entry into the electrical connection of the inlet terminal 111 to the commercial power source.

The main controller 134 has the main-controller digital-communication section 139 and communicates digitally with the module controller 122 through the main-controller digital-communication section 139 and the module-controller digital-communication section 132.

The discharge control section 140 is for converting a DC voltage of a group of series-connected battery cells 120 into an AC voltage, and, in an alternative, the discharge control section 140 may preferably take an arrangement other than four (4) FETs as long as the same goal can be achieved. The discharge control section 140 is preferably arranged to maintain an AC output which is equivalent to the effective value of the commercial power source, irrespective of how much the state of charge of the battery cells 120 is. Particularly, the discharge control section 140 is preferably arranged to detect the DC voltage of the battery cell group, and control a time duration spent at 0 volts while output. As a result, the user becomes able to work without noticing any reduction in the output resulting from a decrease in the state of charge of the battery cells 120.

In addition, while it will be described below at the description of a third embodiment of the invention, the output of the battery pack 100 may be, but not limited to an AC voltage as described above, a positive or negative DC voltage which is selected in accordance with a signal received from the electric device, which can improve performance in the intended use of the electric device.

The charge control section 141 is disposed for the purpose of supplying a DC current from the commercial power source to the battery cell group which is connected with the commercial power source in series, while controlling the amount of current to be supplied, using a device which is not limited to one (1) SCR if the same purpose can be achieved.

Particularly in a charge control process, the charge control section 141 performs charge control such that the charging current is kept constant without exceeding an upper limit of current, until the Li-ion battery voltage reaches a predetermined voltage, and such that the battery voltage is maintained at the predetermined voltage after the Li-ion battery voltage has reached the predetermined voltage. For example, the charge control section 141 preferably detects a battery cell voltage and a charging current, and controls firing angles of the SCR so that the charging current and the charging voltage can reach their respective target values.

It is added that, in an embodiment of the present invention, the battery pack 100 houses the charge control section 141, but in an alternative arrangement, the charge control section 141 may be disposed outside of the battery pack 100 and configured as a charger which is physically separated from the battery pack 100 and which has a case within which a device for recognizing the state of the battery pack 100 and a device for allowing electrical connection with the battery pack 100 are disposed.

For digital communications between the module controllers 122 and the main controller 134, the module controllers 122 of three (3) battery modules 112 are grounded to have mutually different electrical potentials, and therefore, in a preferable example, a photocoupler may be disposed within a selected one of each battery module 112 and the main controller 134, to thereby perform digital communications with electrical insulation securely provided.

It is added that communications between the main controller 134 and the module controllers 122 is for associating or synchronizing control of the main controller 134 and control of the module controllers 122, each other, and therefore, the communications may be alternatively performed using analog signals corresponding to the following signals, respectively:

a first signal (equivalent to “a first signal” described in above mode (1)) indicating that the output to the discharge output terminal 110 is disabled, when the main controller 134 attempts to disable the output to the discharge output terminal 110;

a second signal indicating that the output to the module input/output section 131 is disabled, when the module controller 122 attempts to disable the output to the module input/output section 131;

a third signal (equivalent to “second signal” described in the above mode (3)) indicating that the input to the battery module group for charging is disabled, when the main controller 134 attempts to disable the input to the battery module group; and

a fourth signal indicating that the input to the battery cell group for charging is disabled, when the module controller 122 attempts to disable the input to the battery cell group.

In addition, for the second and fourth signals, instead of using an exclusive terminal for transmission of the second and fourth signals, the main controller 134 maybe alternatively configured to measure the voltage of the battery module 112 of each battery module 112. The main controller 134 may be further configured to detect an event of a voltage change of the battery module 112 occurring when each battery module 112 disables the input/output operation (e.g., an event in which the voltage of each battery module 112 has been zeroed when the input/output operation is blocked, or an event in which the voltage of each battery module 112 has changed by a predetermined amount or more during a predetermined length of time when the input/output operation is blocked). The main controller 134 may be still further configured to enter an operation stage after reception of the second and fourth signals, by treating the detection of the event of voltage change as the reception of the second and fourth signals.

Moreover, instead of providing each battery module 112 with an exclusive terminal for communicating the second and fourth signals, each battery module 112 is provided with a new terminal for communicating information having a principle purpose of indicating events (e.g., a voltage, a current, a temperature at each segment in each battery module 112, module individual ID numbers, etc.) other than an event in which the input/output operation of each battery module 112 is disabled, and using the new terminal, the information may be modulated to show a specified change when the input/output operation of each battery module 112 is disabled.

FIG. 20 is a side view illustrating the interior structures of the battery pack 100 and the cordless power tool 200, when connected.

Upon insertion of the battery pack 100 into the cordless power tool 200, the terminal block 207 of the cordless power tool 200 pushes the outlet cover 107 of the battery pack 100 for imparting slide movement thereto. The outlet cover switch 116, after brought into physical contact with the outlet cover 107, moves integrally with the outlet cover 107, and eventually turns ON at a location which allows the power-input terminal 208 of the cordless power tool 200 to be brought into electrical contact with the terminal 110 of the battery pack 100.

The hook-button 103 of the battery pack 100 is fixedly received in the engagement recess 206 of the cordless power tool 200, and the battery pack 100 is held secured to the cordless power tool 200 until the hook-button 103 is released. In this state, the battery pack 100 determines whether discharging is permitted or not, and, if so, enters a discharging state permitting the cordless power tool 200 to be activated.

FIG. 21 is a side view illustrating the interior structures of the battery pack 100 and the outlet plug 201, when connected.

Upon insertion of the outlet plug 301 of the AC power tool 300 into the battery pack 100, the outlet plug 301 pushes the outlet cover 107 of the battery pack 100 for imparting slide movement thereto. The outlet cover switch 116, after brought into physical contact with the outlet cover 107, moves integrally with the outlet cover 107, and eventually turns ON at a location allowing the outlet plug 301 is brought into electrical contact with the terminal 110 of the battery pack 100. In this state, the battery pack 100 determines whether discharging permitted or not, and, if so, enters a discharging state permitting the AC power tool 300 to be activated.

FIG. 22 is a side view illustrating the interior structures of the battery pack 100 and the electrical cord 280, when connected.

Upon insertion of the power-supply terminal 282 of the electrical cord 280 into the inlet 108 of the battery pack 100, the commercial power source is connected for power supply to the inlet terminal 111 of the battery pack 100. In this state, the outlet cover 107 does not move and the outlet cover switch 116 is OFF. However, the main controller 134 detects the insertion of the electrical cord 280 into the battery pack 100, by means of the inlet detector 135, determines whether charging is permitted or not, and, if so, enters a charging state permitting the battery pack 100 to be charged.

FIG. 23 is a side view illustrating the interior structures of the battery pack 100 and the electrical cord adaptor 250, when connected.

Upon insertion of the power-supply terminal 257 of the electrical cord adaptor 250 into the battery pack 100, the commercial power source is connected for power supply to the inlet terminal 111 of the battery pack 100. In this state, the electrical cord adaptor 250 pushes the outlet cover 107 for imparting slide movement thereto, to thereby turn ON the outlet cover switch 116, The main controller 134 does not determine whether charging is permitted or not, based on the ON state, but the main controller 134 detects the insertion of the power-supply terminal 257 into the battery pack 100, by means of the inlet detector 135, determines whether charging is permitted or not, and, if so, enters a charging state permitting the battery pack 100 to be charged.

In this state, while the electrical cord adaptor 250 is electrically connected with the commercial power source, the AC voltage of the commercial power source is constantly impressed to the power-supply terminal 257. Therefore, the power-supply terminal 257 has a protruded shape (i.e., a male shape) formed by covering a conductive terminal with electrically-insulating material for prevention of electric shock, and a casing has a recessed shape (i.e., a female shape), which encloses around the inlet terminal 111 of the battery pack 100 engaged with the power-supply terminal 257.

In addition, the guide recesses 109 of the battery pack 100 slidably receive the front ends 259 of the slide rails of the electrical cord adaptor 250. The hook-button 254 of the electrical cord adaptor 250 is fixed to the engagement recess 104 of the battery pack 100, and the electrical cord adaptor 250 is held fixed to the battery pack 100 until the hook-button 254 is released.

FIG. 24 is a side view illustrating the interior structures of the cordless power tool 200 and the electrical cord adaptor 250, when connected.

The slide rails 255 of the electrical cord adaptor 250 can be inserted into and along the guide rails 205 of the cordless power tool 200, like the slide rails 105 of the battery pack 100. Once the hook-button 254 of the electrical cord adaptor 250 has been inserted into the engagement recess 206 of the cordless power tool 200 up to a location allowing the hook-button 254 to be fixed to the engagement recess 206, the power-input terminal 208 which is disposed at the terminal block 207 of the cordless power tool 200 is brought into an electrical connection with the power-supply terminal 256 of the electrical cord adaptor 250, which allows the electrical cord adaptor 250 to supply electricity to the AC motor 210 of the cordless power tool 200.

As illustrated in FIG. 23, the electrical cord adaptor 250 has a casing shaped to be engaged with the battery pack 100 for the purpose of charging the battery pack 100. For this reason, the electrical cord adaptor 250 has the power-supply terminal 257 which has a protruded shape formed by covering a conductive terminal with electrically-insulating material for prevention of electric shock.

On the other hand, the cordless power tool 200 has the power-input terminal 208 for receiving electrical power from the battery pack 100 and the electrical cord adaptor 250. The outlet terminal 110 of the battery pack 100, which is engaged with the power-input terminal 208, and the power-supply terminal 256 of the electrical cord adaptor 250 have recessed shapes which prevent direct access by hand, for prevention of electric shock, because the outlet terminal 110 and the power-supply terminal 256 output high voltage which is comparable to that of the commercial power source. Therefore, the power-input terminal 208 has a protruded shape.

In addition, a conventional cordless power tool has only a terminal for inputting of power from the battery pack 100, and the terminal is equivalent to the power-input terminal 208 in the cordless power tool 200 according to an exemplary embodiment of the present invention.

However, if, according to a conventional technology, the user attempts to attach the electrical cord adaptor 250 to a cordless power tool which has a conventional configuration, then the electrical cord adaptor 250 cannot be attached to the cordless power tool due to mutual interference, because the electrical cord adaptor 250 has the protruded power-input terminal 208 for charging the battery pack 100.

Then, in one implementation of the invention, the terminal block 207 made of electrically-insulating material within the cordless power tool 200 includes a dummy recess 209 in which there is no electrical conduction. The power-input terminal 208 is stored in the dummy recess 209 in which there is no electrical conduction, when the electrical cord adaptor 250 is electrically connected with the cordless power tool 200.

This would provide a configuration which allows the battery pack 100, the electrical cord adaptor 250 and the cordless power tool 200, all of which are constructed according to an embodiment of the present invention, to be engaged between any one of combinations of two of these three elements.

As shown in FIGS. 23 and 24, the electrical cord adaptor 250 can be electrically connected with any one of the battery pack 100 and the cordless power tool 200, and the electrical cord 252 of the electrical cord adaptor 250 is preferably oriented in a different direction from a direction in which the electrical cord adaptor 250 moves relative to a selected one of the battery pack 100 and the cordless power tool 200 for allowing electrical connection.

Particularly, when the electrical cord 252 is oriented along a phantom line which extends from the motor housing 201 of the cordless power tool 200 to the handle 203, it is easier to arrange the electrical cord 252 when used, providing a user with improved ease-to-use.

As is evident from the foregoing, by virtue of the battery pack 100, the cordless power tool 200 and the electrical cord adaptor 250, all of which are constructed according to an embodiment of the present invention, there can be provided a cordless power tool system which is highly evaluated because of a good balance between the weight, the level of power output, the length of run time, initial cost and running cost, all of a battery pack 100.

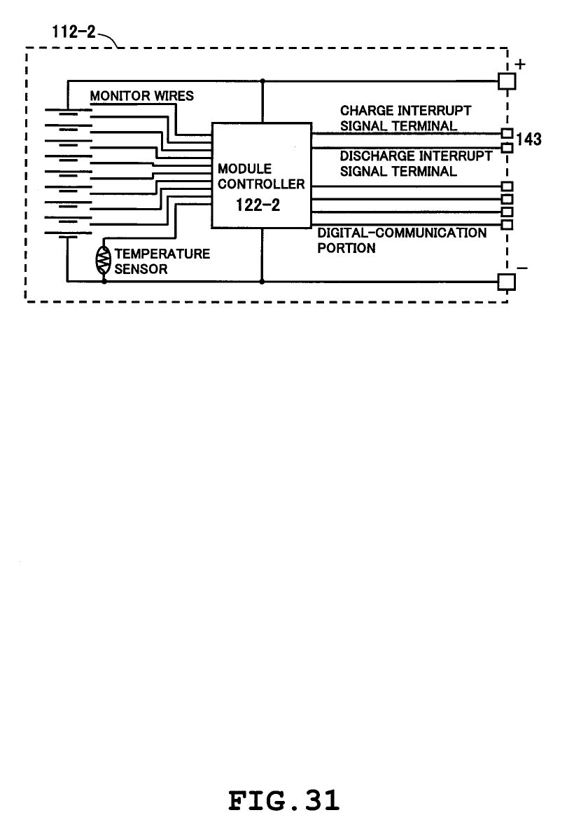

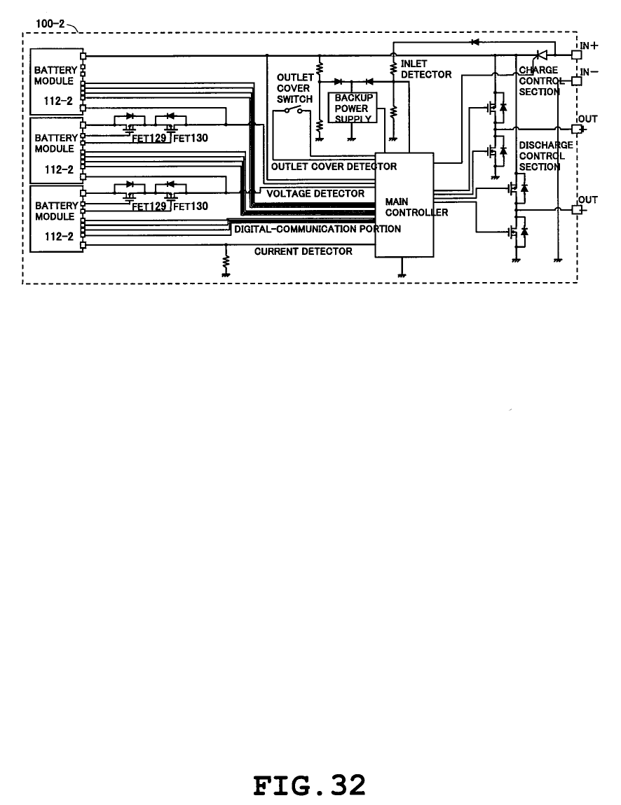

With reference to FIGS. 31 and 32, a battery pack 100-2 will be next described which is constructed according to a second embodiment of the present invention.

The battery module 112 which is housed within the battery pack 100 according to the first embodiment has the FET 129 for module charge (i.e., one example of the “second selector” set forth in the above mode (3)) and the FET 130 for module discharge (i.e., one example of the “first selector” set forth in the above mode (1)). Because of heat generation in each FET 129, 130 described above when conducting current, the undesirable heat is propagated to the battery cell group within the battery module 112, resulting in a fear of reducing the length of the life-time of the battery cell group. Then the second embodiment will be described as an embodiment which can solve this problem.

FIG. 31 is a functional block diagram illustrating the battery module 112-2 within the battery pack 100-2 according to the second embodiment.

Within the battery module 112-2 according to the present embodiment, the FET 129 for module charge and the FET 130 for module discharge are not included, although they are included within the battery module 112 in the first embodiment. A module controller 122-2 has a device configured to determine whether charging is permitted and whether discharging is permitted, and a device configured to transmit to a charge/discharge interrupt signal terminal 143 a signal for connect/disconnect control of by the FETs 129, 130. The connect/disconnect control is performed in the same manner as in the first embodiment.

FIG. 32 is a functional block diagram illustrating the battery pack 100-2 according to the second embodiment of the present invention.

A plurality of battery modules 112-2 are electrically interconnected in series, with the FET 129 for module charge and the FET 130 for module discharge interposed between adjacent ones of the battery modules 112-2. The FETs 129, 130 are electrically connected with the charge/discharge interrupt signal terminal 143, and the module controller 122-2 performs the connect/disconnect control.

All of the battery modules 112-2 may be electrically connected with the respective FETs 129 for module charge and the respective FETs 130 for module discharge. However, in the present embodiment, as illustrated in FIG. 32, the serially-connected battery modules 112-2 are electrically connected with the FETs 129, 130, excepting one of the battery modules 112-2 which is disposed at a positive end, which reduces the total number of components used in the battery pack 100-2, and promotes cost down, while ensuring the reliability in the electrical insulation at the comparable level to the first embodiment of the invention.

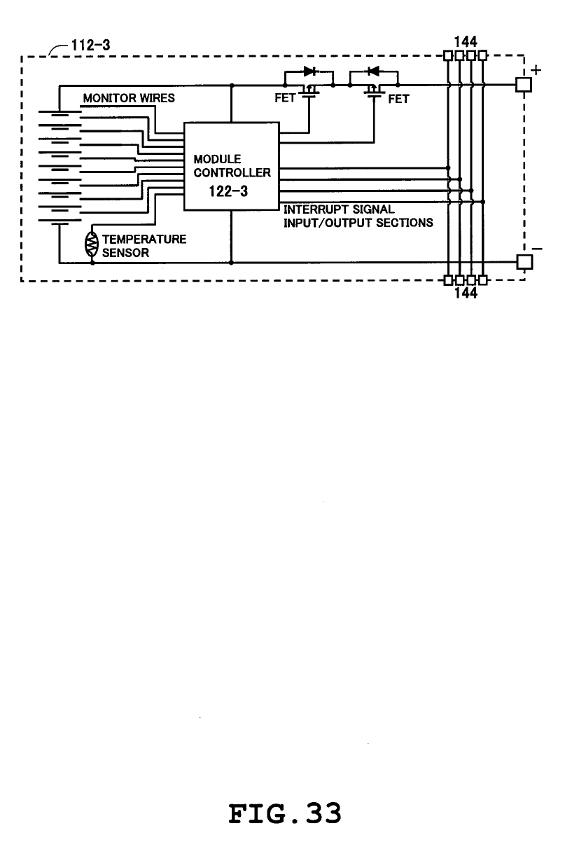

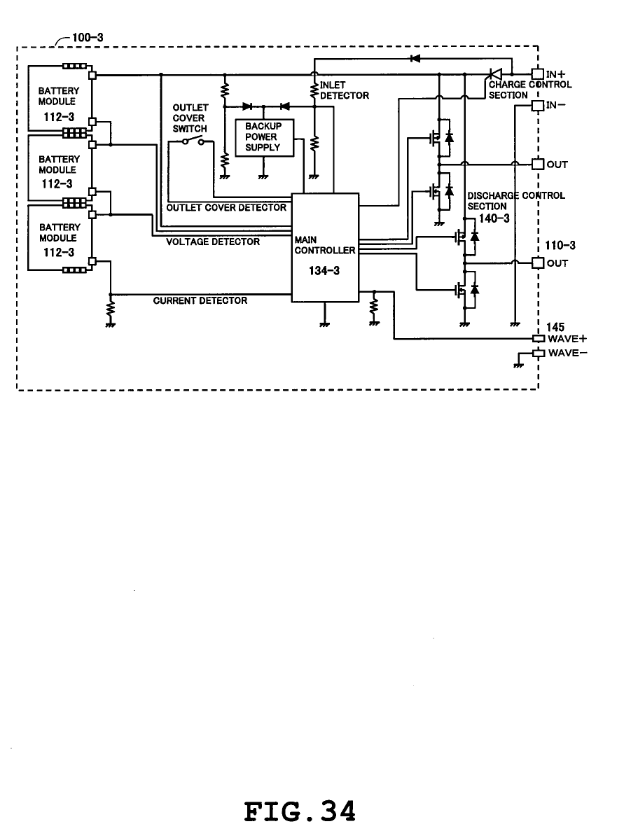

With reference to FIGS. 33 and 34, a battery pack 100-3 will be next described which is constructed according to a third embodiment of the present invention.

In the first embodiment of the invention, the plurality of battery modules 112 and the main controller 134, both of which are housed within the battery pack 100 of the first embodiment, are electrically connected with the main-controller digital-communication section 139 (see FIG. 19) and the module-controller digital-communication section 132 (see FIG. 16) to transmit and receive a signal indicating that the charge/discharge is permitted or not, from the main controller 134 to each battery module 112, or from each battery module 112-3 to the main controller 134.

In the first embodiment, a substrate on which the main controller 134 is disposed requires electrical wires for communication between the main controller 134 and each battery module 112 and circuit layout based on the electrical wires. Particularly, an increase in the number of the battery modules 112 which are housed within the battery pack 100 would cause the circuit layout to be more complex due to an increase in the number of the electrical wires for the communication, resulting in the additional cost.

Then, the third embodiment of the invention will be described as an embodiment which solves this problem.

FIG. 33 is a functional block diagram illustrating the battery module 112-3 within the battery pack 100-3 according to the third embodiment of the invention.

Each battery module 112-3 has inter-module communication terminals 144, instead of the module-controller digital-communication section 132 used in the first embodiment. The module controller 122-3, like the module controller 122 in the first embodiment, has a device configured to determine whether charging is permitted and whether discharging is permitted, and perform control including execution of charge or discharge or interruption of charge or discharge, depending on the determination result.

Each module controller 122-3 has a transmitter configured to transmit a signal indicating a state in which charging and discharging of the corresponding battery module 112-3 are performed or are disabled, to all of the remaining battery modules 112-3 within the battery pack 100-3, through an adjacent one of the remaining battery modules 112-3. Each module controller 122-3 further has a receiver configured to receive a signal indicating a state in which charging and discharging of all of the remaining battery modules 112-3 within the battery pack 100-3, through an adjacent one of the remaining battery modules 112-3, and a device configured to perform control including execution of charge or discharge or interruption of charge or discharge, depending on the content of the received signal.

FIG. 34 is a functional block diagram illustrating the battery pack 100-3 according to the third embodiment of the invention.

The plurality of battery modules 112-3 is electrically interconnected in series, within the battery pack 100-3. In addition, adjacent one of the battery modules 112-3 are interconnected by inter-module communication terminals 144, which enables transmission and reception of signals between all of the battery modules 112-3 within the battery pack 100-3.

In the present embodiment, this approach removes the electrical wires connecting the battery modules 112 with the main controller 134 in the first embodiment, simplifying the circuit layout of the substrate on which the main controller 134-3 in the present embodiment is disposed and, in particular, the effect of cost down because of the removal of those wires increases as the number of battery modules 112-3 within the battery pack 100-3 increases.

In addition, in the first embodiment, a disable signal is transmitted from the battery modules 112 to the main controller 134 when the charge/discharge of at least one battery module 112 within the battery pack 100 is disabled, and a disable signal is transmitted from the main controller 134 to the battery modules 112 when the main controller 134 is disabled upon reception of the former disable signal, to thereby allow the charge/discharge of the remaining battery modules 112 to be disabled in a linked relation. The effect is also achieved in the third embodiment, and therefore, any one of the first and third embodiments can be selected depending on the number of the battery modules 112, 112-3.

In the present embodiment, each module controller 122-3 constructs an example of the “module control circuitry” set forth in the above mode (2) or (4).

In addition, the battery pack according to one embodiment of the present invention includes a battery cell group in which battery cells are interconnected in series, and discharge control circuitry for converting DC voltage of the battery cell group into AC voltage, which solves a new problem in a cordless power tool. This will be next described with reference to FIG. 34 illustrating the third embodiment.

The battery pack 100-3 illustrated in FIG. 34 includes: a battery module group in which the battery modules 112-3 are interconnected in series; a discharge control section 140-3 for converting DC voltage of the battery module group into AC voltage; a main controller 134-3 configured to transmit a control signal to the discharge control section 140-3; a terminal 110-3 for discharge through which output power from the discharge control section 140-3 is supplied to the cordless power tool; and a voltage-property-indication input terminal 145 for transmitting to the battery pack 100-3 a signal indicating an output voltage property required by the cordless power tool combined with the battery pack 100-3, and for allowing the main controller 134-3 to receive the signal.

If the cordless power tool, for example, outputs a signal voltage of 0 volts impressed to the voltage-property-indication input terminal 145, then the main controller 134-3 of the battery pack 100-3 combined with the cordless power tool detects 0 volts, controls the discharge control section 140-3 to convert a DC voltage of a battery module 112-3 group into an AC voltage, and to output the AC voltage from the discharge terminal 110-3.

Alternatively, if the cordless power tool outputs the signal voltage of 3 volts, then the discharge control section 140-3 provides direct output of the DC voltage of the battery module group in a positive voltage, to the discharge terminal 110-3. Moreover, if the cordless power tool outputs the signal voltage of 4 volts, then the discharge control section 140-3 disables output to the discharge terminal 110-3.

Furthermore, if the cordless power tool outputs the signal voltage of 5 volts, the discharge control section 140-3 converts the DC voltage of the battery module group to a negative voltage to be outputted from the discharge terminal 110-3.

The foregoing approach can provide variable types of voltage input from the battery pack 100-3 to a motor within the cordless power tool, such as, a positive voltage, a negative voltage, an AC voltage produced by alternating positive and negative voltages at a desired frequency, or a square wave produced by alternating a positive voltage and zero at a desired frequency, or alternating a negative voltage and zero at a desired frequency.

For example; when, according to a conventional technology, an AC power tool powered by the commercial power source employs a high-efficiency motor intended to be driven by DC only, incorporation of control circuitry for converting the AC voltage supplied from the commercial power source into the DC voltage within the power tool causes cost up for the power tool.

In the battery pack 100-3 according to the third embodiment of the present invention, direct supply of a desired voltage in response to a demand from the power tool side can reduce the number of components within the power tool and can improve output efficiency of the motor.

Conventionally, some cordless power tools have a selector switch for changing the direction of the motor rotation between positive and negative. In the cordless power tool which employs the foregoing approach described for the third embodiment, however, such a selector switch within the cordless power tool can be eliminated, and only transmission of a signal demanding the change of the direction of the motor rotation, to the connected battery pack 100-3 according to the third embodiment enables the direction of the motor rotation to change between positive and negative.

As a result, in the present embodiment, a device for switching between positive and negative which is housed within the cordless power tool can be constructed as a device merely for transmitting the signal, with no need for a large current conduction within the cordless power tool.

A conventional selector switch, which requires a large current passage while being nevertheless disposed within a limited space within the cordless power tool, has a problem such as reduced durability and cost up for improving durability. The third embodiment of the present invention can solve such a problem.

When the signal voltage inputted to the voltage-property-indication input terminal 145 is 0 volts, the battery pack 100-3 outputs the AC voltage through the discharge terminal 110-3, and therefore, when the battery pack 100-3 is electrically connected with a conventional AC power tool, the AC power tool can be driven. As a result, the battery pack 100-3 is compatible with a power tool whether connectable or non-connectable to the voltage-property-indication input terminal 145.

It is added that the voltage inputted to the voltage-property-indication input terminal 145 and the voltage outputted through the discharge terminal 110-3 may preferably have a correlation therebetween, but not limited in type to the foregoing embodiments. In addition, a device for instructing the voltage property may be of a type that can transmit the instruction from the power tool side to the battery pack side, and, the device for instructing can cover, for example, a wireless signal transmission.

For the purpose of achieving the compatibility of both an AC-enabled power tool and a DC-enabled power tool, an alternative approach may be employed to provide a battery pack with a switch, and to engage the battery pack with a power tool, for example, such that, when the battery pack is electrically connected with the DC-enabled power tool, the switch is electrically closed by being pushed by a portion of the DC-enabled power tool, when the battery pack is electrically connected with the AC-enabled power tool, the switch remains open without being pushed, and the battery pack outputs the DC voltage when the switch is closed and in an ON state and the AC voltage when the switch is opened and in an OFF state.

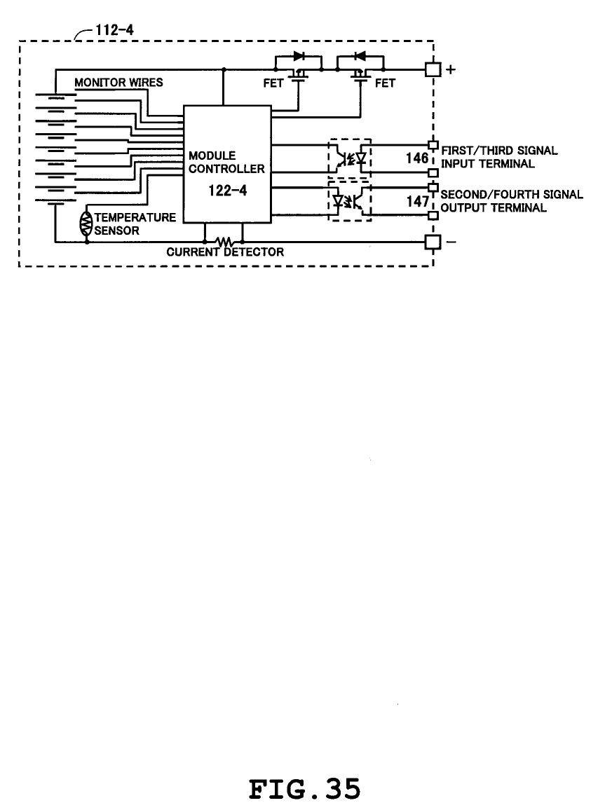

With reference to FIGS. 35-37, a battery pack 100-4 will be next described which is constructed according to a fourth embodiment of the present invention.

In the battery pack according to the first embodiment of the present invention, for the purpose of improving the reliability in electrical insulation, digital communication is performed by way of an example of communication, for transmission and reception of the first to fourth signals for disabling charge/discharge between each battery module 112 and the main controller 134 and for the control based on the signal transmission/reception.

On the other hand, in the fourth embodiment, in addition to the reliability in electrical insulation to an extent equivalent to that of the first embodiment, cost down is achieved owing to simplification of the circuit configuration. The location of a device for controlling the output of a DC voltage of a battery module group in the form of a plurality of battery modules electrically interconnected in series and a device for controlling the charge of the battery module group, is optional, and these devices may be located within a battery pack such as in the first embodiment, or may be located outside of a battery pack such as in the fourth embodiment. The output of a battery pack is also optional, and it may be a DC voltage, an AC voltage, or any one of other types of voltage.

In an implementation of the present invention, any one of combinations of any one of the aforementioned location options and any one of the aforementioned output-type options would provide an effect of improvement in the reliability in electrical insulation to the equal extents. This makes it possible to expand an option range of the interior configuration of a battery pack, and an electric device, a charger and an electrical cord adaptor, all of which are available for the battery pack, depending on the use of the products, while ensuring high reliability in electrical insulation.

FIG. 35 is a functional block diagram illustrating a battery module 112-4 which is housed within the battery pack 100-4 according to the fourth embodiment of the invention.

The battery module 112-4 includes a first/third signal input terminal 146 (including a pair of positive and ground pins or contacts) and a second/fourth signal output terminal 147 (including a pair of positive and ground pins or contacts), instead of the module-controller digital-communication section 132 included in the first embodiment of the invention.

In one battery pack 100-4 in which a plurality of battery modules 112-4 are electrically interconnected in series, the first/third signal input terminal 146 (for battery module) and the second/fourth signal output terminal 147 (for battery module), which are included in each battery module 112-4, are electrically connected with another terminals 146 and 147 of another battery modules 112-4, at different levels of ground potential, and therefore, in a preferable example, a device such as a photocoupler may be disposed, which can transmit an electrical signal while ensuring electrical isolation.

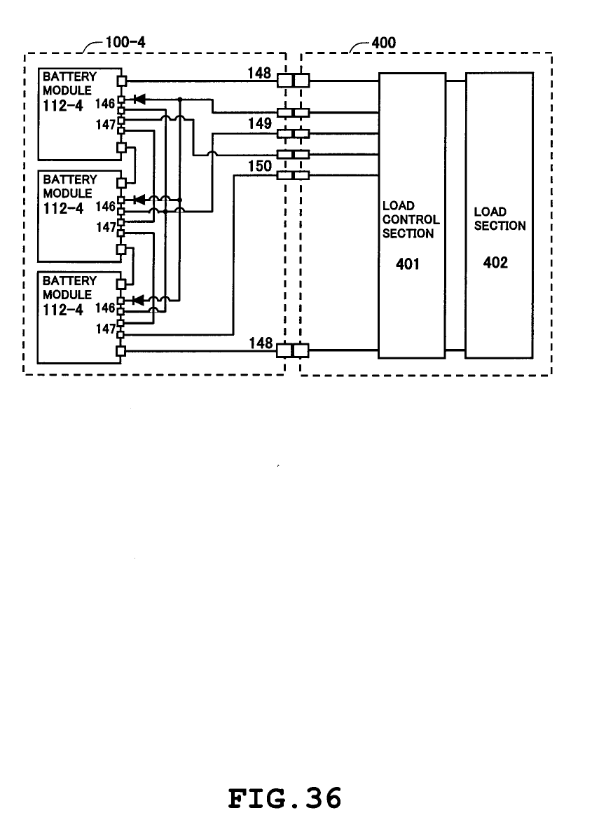

FIG. 36 is a functional block diagram illustrating a battery pack 100-4 according to the fourth embodiment of the invention and an electric device 400 available for the battery pack 100-4.

The plurality of battery modules 112-4 are interconnected in series and are housed within the battery pack 100-4. The first/third signal input terminals 146 of the battery modules 112-4 are electrically connected with first/third signal input terminals 149 (for battery pack), in parallel. In addition, the second/fourth signal output terminals 147 (for battery module) of the battery modules 112-4 are electrically connected with second/fourth signal output terminals 150 (for battery pack), in series.

The electric device 400 connected with the battery pack 100-4 includes a load section 402 and a load control section 401 which controls the load section 402 powered by a DC voltage (detected by a battery-module-voltage detector 137) from an input/output terminal 148 of the battery pack 100-4.

When it is in a state in which the discharging is not permitted, for example, one of a state in which a DC voltage supplied from the input-output terminal 148 of the battery pack 100-4 is lower than a predetermined voltage, a state in which the battery pack 100-4 was unused for a predetermined length of time, and a state in which the load section 402 cannot be operated normally, the load control section 401 disables power supply to the load section 402, and then sends to the first/third signal input terminal 149 (for battery pack), a first signal indicating that the power supply is disabled.

The battery module controller 122-4 of each battery module 112-4 receives the first signal through each first/third signal input terminal 146 which is electrically connected with the first/third signal input terminal 149 (for battery pack), and then disables the output operation.

In the present embodiment, the load control section 401is housed within the electric device 400, and operates so as to disable power output from each battery module 112-4, based on a detection result of the battery-module-voltage detector 137, via the battery module controller 122-4 within each battery module 112-4. This load control section 401 constructs an example of the “discharge control circuitry” in the above-described mode (11).

Conventionally, even if the electric device side disables its own operation, because of no reception of the first signal, all battery cell groups within a battery pack is held in an electrical conduction state, and therefore, a high voltage of all battery cells which are electrically interconnected in series is constantly impressed to each segment within the battery pack, which causes a problem that the reliability in electrical insulation is degraded.

On the other hand, in the fourth embodiment of the present invention, the battery pack 100-4 receives the first signal from the outside of the battery pack 100-4, and the battery modules 112-4, in parallel, receive the first signals and disable output operation of the battery modules 112-4. This allows a voltage of the battery cell group in which the battery cells are electrically interconnected in series, within the battery pack 100-4, to be blocked per each battery module 112-4, with improved reliability in electrical insulation.

In addition, the use of the second/fourth signal output terminal 147 (for battery module) included in each battery module 112-4 synergistically improves the reliability in electrical insulation. Each battery module 112-4 detects a state of the battery cell group housed within each battery module 112-4, and, if each battery module 112-4 detects a state in which the battery cell group are not permitted to be discharged, for example, at least one of an overdischarging state, an overloaded state, a state in which the battery cell temperature falls outside an allowable range for discharging, and a state in which the battery pack 100-4 was unused for a predetermined length of time (i.e., a reference length of time), each the battery module 112-4 disables output operation of each battery module 112-4.

Conventionally, if one of a plurality of battery modules disables its own output operation, then the remaining battery modules are held in an electrical conduction state. In this state, the plurality of battery modules in an electrical conduction state remains serial connection within the battery pack, and therefore, a high voltage of the plurality of battery modules in an electrical conduction state is frequently impressed to every segment within the battery pack, which causes degraded reliability in electrical insulation.

Then, in the fourth embodiment of the present invention, if the battery module controller 122-4 of one of the battery modules 112-4 among the battery module group housed within the battery pack 100-4 disables the output operation, then the battery module controller 122-4 transmits to the load control section 401 a second signal indicating that the output operation is disabled, through the second/fourth signal output terminal 147 (for battery module) and the second/fourth signal output terminal 150 (for battery pack).

The load control section 401 receives the second signal, performs a operation stop process of the load section 402, and transmits to all battery modules 112-4 the first signal. Each battery module 112-4 which has received the first signal can disable the output operation.

It is added that the second/fourth signal output terminals 147 (for battery module) of the battery modules 112-4 are electrically connected with the second/fourth signal output terminal 150 (for battery pack) in series. Therefore, once at least one of the battery modules 112-4 of the battery module group housed within the battery pack 100-4 transmits the second signal to the load control section 401, allows the load control section 401 to receive and detect the second signal, irrespective of where the at least one battery module 112-4 transmitting the second signal is located relative to the remaining battery modules 112-4.

This, as long as at least one of the plurality of battery modules 112-4 disables its output operation, even if the remaining battery modules 112-4 do not disables their output operation, the above-described approach allows all of the remaining battery modules 112-4 to disable the output operation, and to reduce a maximum possible voltage impressed to every section within the battery pack 100-4 to be lower than voltage worth one battery module 112-4, with further improvement in the reliability in electrical insulation.

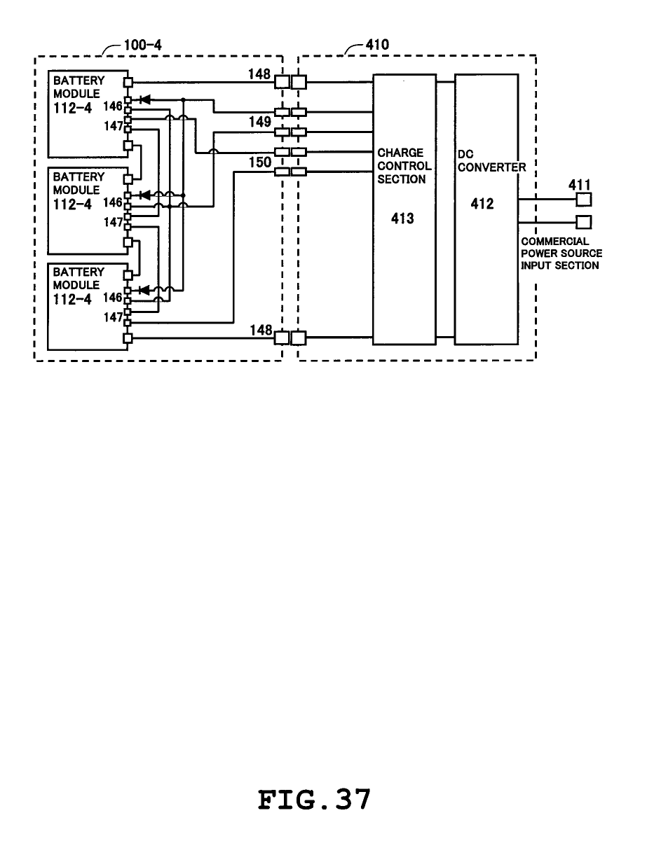

FIG. 37 is a functional block diagram illustrating a battery pack 100-4 according to the fourth embodiment of the invention and a charger 410 available for the battery pack 100-4.

The plurality of battery modules 112-4 are interconnected in series and are housed within the battery pack 100-4. The first/third signal input terminals 146 of the battery modules 112-4 are electrically connected with the first/third signal input terminal 149 (for battery pack), in parallel. In addition, the second/fourth signal output terminals 147 (for battery module) of the battery modules 112-4 are electrically connected with the second/fourth signal output terminal 150 (for battery pack), in series.

The charger 410 includes a DC converter 412 configured to receive an AC voltage of the commercial power source from a commercial power source input section 411, and to convert the AC voltage into a DC voltage; and a charge control section 413 configured to control the DC voltage to charge the battery modules 112-4 within the battery pack 100-4 via the input/output terminal 148 of the battery pack 100-4.

When it is in a state in which the charging is not permitted, for example, one of a state in which the battery pack 100-4 has been fully charged, a state in which the input voltage delivered from the commercial power source input section 411 is unsuitable for charge of the battery pack 100-4, and a state in which a circuit element or the like which constitutes the charge control section 413 is failed, the charge control section 413 disables the charge of the battery pack 100-4 and sends to the first/third signal input terminal 149 (for battery pack) the third signal indicating that the charge is disabled.

The battery module controller 122-4 of each battery module 112-4 receives the first signal through each first/third signal input terminal 146 which is electrically connected with the first/third signal input terminal 149 (for battery pack) in parallel, and then disables its input operation.

In the present embodiment, it is determined whether the battery pack 100-4 is fully charged or not, based on a detection result from the battery-module-voltage detector 137 or a current detector 138. The current detector 138 is configured to detect a charging current of the battery pack 100-4, while the battery-module-voltage detector 137 is configured to detect a charging voltage of at least one of battery cells 120 in the battery cell group housed within each battery module 112-4. These charging current and charging voltage are physical quantities associated with a determination as to whether the battery pack 100-4 is fully charged or not.

In the present embodiment, the charge control section 413 is housed within the charger 410, and operates to disable the charge of each battery module 112-4 (i.e., input of a voltage from the charger 410 to each battery module 112-4), based on a detection result of the battery-module-voltage detector 137 or the current detector 138, via the module controller 122-4 within each battery module 112-4. This charge control section 413 constructs an example of the “charge control circuitry” set forth in the above-described mode (12).

Conventionally, even if the charger disables the charge of the battery pack, because of no third signal described above, all the battery cell groups within the battery pack is held in an electrical conduction state. As a result, a high voltage of all the battery cells which are electrically interconnected in series is constantly impressed to every segment within the battery pack, which causes a problem that the reliability in electrical insulation is degraded.

On the other hand, in the fourth embodiment of the present invention, the battery pack 100-4 receives the third signal from the outside of the battery pack 1004, and, the battery modules 112-4 receive the third signal in parallel, and disable output operation of the battery modules 112-4. This allows a voltage of the battery cell group in which the battery cells are electrically interconnected in series, within the battery pack 100-4, to be blocked per each battery module 112-4, with improvement in the reliability in electrical insulation.

In addition, the use of the second/fourth signal output terminal 147 (for battery module) included in the battery module 112-4 synergistically improves the reliability in electrical insulation. The battery module 112-4 detects a state of the battery cell group housed within the battery module 112-4, and, if the battery module 112-4 detects a state in which the battery cell group are not permitted to be charged, for example, at least one of an overcharging state, an charging state with over-current, and a state in which the battery cell temperature falls outside an allowable range for charging, then each battery module 112-4 disables input operation of each battery module 112-4.

Conventionally, if one of a plurality of battery modules disables charge, then the remaining battery modules are held in an electrical conduction state. In this state, a plurality of battery modules in an electrical conduction state remains as serial connection within the battery pack, and therefore, a high voltage of the plurality of battery modules in an electrical conduction state is frequently impressed to every segment within the battery pack, which causes degraded reliability in electrical insulation.

Then, in the fourth embodiment of the present invention, if the battery module controller 122-4 of one of the battery modules 112-4 among the battery module group housed within the battery pack 100-4 disables the charge, then the battery module controller 122-4 transmits to the charge control section 413 a fourth signal indicating that the charge is disabled through the second/fourth signal output terminal 147 (for battery module) and the second/fourth signal output terminal 150 (for battery pack). The charge control section 413 receives the fourth signal, then performs a charge disabling process for the battery pack 100-4, and transmits to all the battery modules 112-4 the third signal, and then each battery module 112-4 which has received the third signal can disable the charge.

It is added that the second/fourth signal output terminals 147 (for battery module) of the battery modules 112-4 are electrically connected with the second/fourth signal output terminal 150 (for battery pack) in series. Therefore, once at least one of the battery modules 112-4 of the battery module group housed within the battery pack 100-4 transmits the fourth signal to the charge control section 413, the charge control section 413 receives and detects the fourth signal, irrespective of where the at least one battery module 112-4 transmitting the fourth signal relative to the remaining battery modules 112-4.

This, as long as one of the plurality of battery modules 112-4 disables the charge, even if the remaining battery modules 112-4 do not disable the charge, the above-described approach allows all of the remaining battery modules 112-4 to disable the charge and to reduce a maximum possible voltage impressed to every section within the battery pack 100-4 to be lower than a voltage worth one battery module 112-4, with further improvement in the reliability in electrical insulation.

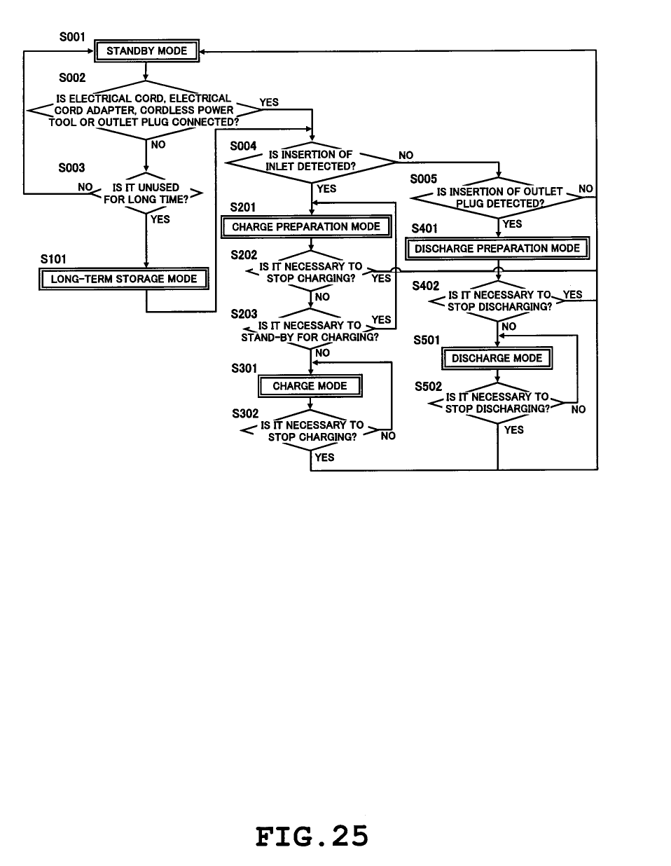

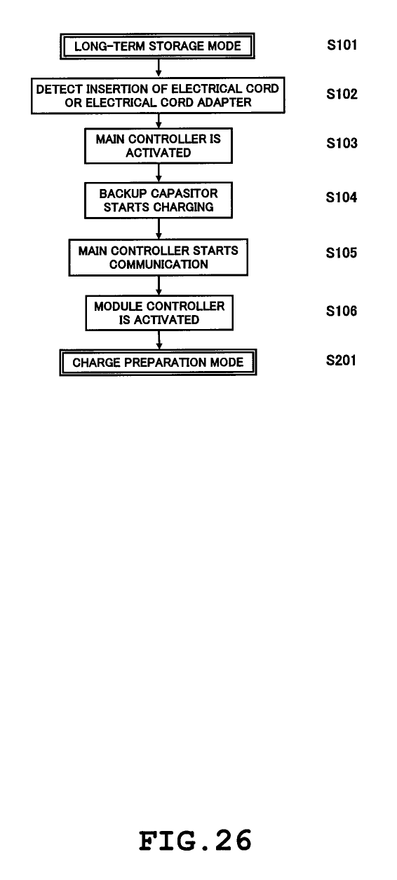

The battery pack 100 combined with the cordless power tool system, which is constructed according to an embodiment of the present invention will be described below with reference to flowcharts, with respect to its electrical control. FIG. 25 schematically illustrates the whole operation of the battery pack 100, while FIGS. 26-30 each illustrate its detailed operation.

FIG. 25 illustrates in a flowchart, a basic operation of the battery pack 100.

The state of each control section in a standby mode at step S001 will be described below. The module controller 122 is placed in a standby mode in preparation for entry into the next step, while being powered by the battery cells 120 within the battery module 112.

Both the FET 129 and the FET 130 of the battery module 112 are each in an OFF state. The main controller 134 is placed in a standby mode in preparation for entry into the next step, while being powered by an electricity storage such as a backup capacitor which is a part of the power supply circuit 133 with a battery backup function, because the main controller 134 cannot be powered by the battery module 112. The FETs of the discharge control section 140 and the SCR of the charge control section 141 under the control of the main controller 134 are also each in an OFF state.

At step S002, if any one of the electrical cord 280, the electrical cord adaptor 250, the cordless power tool 200, and the outlet plug 301 of the AC power tool 300 is electrically connected with the battery pack 100, then the process proceeds to step S004.

At step S003, if the standby mode at step S001 continues for a long term, then it enters a long-term storage (preservation) mode at step S101. Because the state of charge (remaining capacity) of the electricity storage such as a backup capacitor which is a part of the power supply circuit 133 with a battery backup function, becomes zero after continuation of the long-term storage mode, the main-controller 134 is turned OFF.

In addition, although the state of charge (remaining capacity) of the battery cells 120 within the battery module 112 is relatively larger than that of the electricity storage, the module controller 122 waits while consuming a very small current smaller than a current consumed in a normal operation, to prevent the deterioration of the battery cell electrodes or the like due to overdischarging. The long-term storage mode at step S101 continues until the inlet 108 is electrically connected and the charging begins at step S004.

At step S004, if either the power-supply terminal 282 of the electrical cord 280 or the power-supply terminal 257 of the electrical cord adaptor 250 is electrically connected with the battery pack 100, then the process first proceeds to a charge preparation mode for an operation prior to the charging at step S201 and then proceeds to a charge mode at step S301. After the charging begins, if it becomes necessary to disable the charge at step S302, then the process returns to the standby mode at step S001.

At step S005, if either the power-input terminal 208 of the cordless power tool 200 or the outlet plug 301 of the AC power tool 300 is electrically connected with the battery pack 100, then the process first proceeds to a discharge preparation mode prior to discharging at step S401 and then proceeds to a discharge mode at step S501. After the discharging begins, if it becomes necessary to disable the discharge at step S502, then the process returns to the standby mode at step S001.

FIG. 26 illustrates in a flowchart, the long-term storage mode of the battery pack 100.

At step S102, if either the power-supply terminal 282 of the electrical cord 280 or the power-supply terminal 257 of the electrical cord adaptor 250 is electrically connected with the battery pack 100, then the power supply circuit 133 with a battery backup function is activated by power supply through a diode 142 which is disposed within the battery pack 100 for detecting the inlet for charging. At step S103, along with the activation of the power supply circuit 133 with a battery backup function, the main controller 134 is activated, and step S104 is followed to start charging of the electricity storage such as a backup capacitor which is a part of the power supply circuit 133 with a battery backup function.

At step S105, the main controller 134 starts digital communications with the module controllers 122 through the main-controller digital-communication portion 139 and the module-controller digital-communication portions 132. At step S106, the module controller 122 is activated in response to the starting of the digital communications, and the process enters the charge preparation mode at step S201.

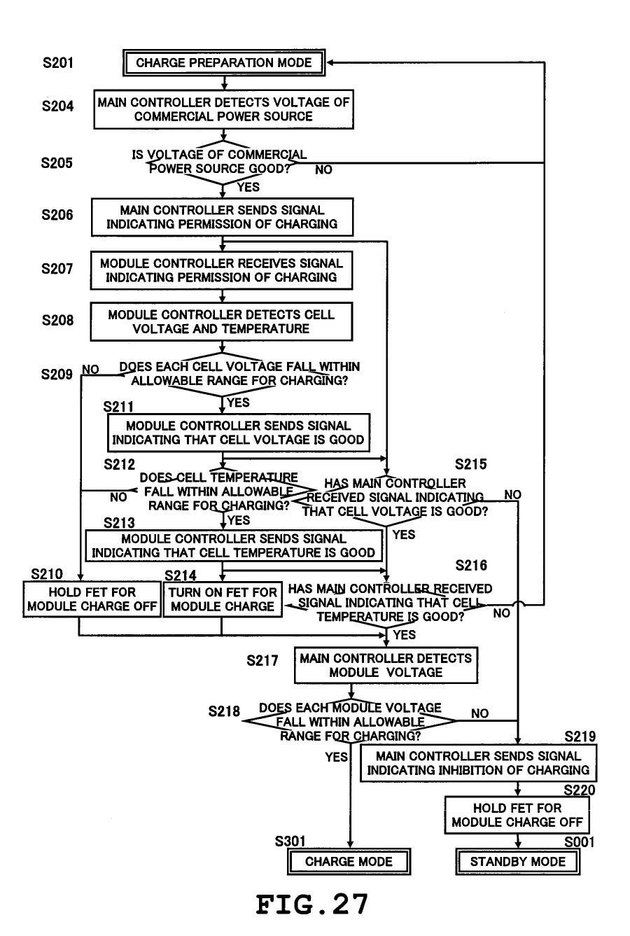

FIG. 27 illustrates in a flowchart, operations in the charge preparation mode of the battery pack 100.

At step S204, the main controller 134 detects the input voltage of the commercial power source. At the step S205, if the detected voltage of the commercial power source falls within an allowable range for charging, then the process proceeds to step S206. If, however, the detected voltage of the commercial power source falls outside the allowable range for charging, then the process returns to the step S201 to protect the circuits within the battery pack 100 from failure due to abnormal voltage input.

At step S206, the main controller 134 transmits to the module controllers 122 instruction signals each of which indicates that charging is permitted. At step S207, the module controllers 122 receive the instruction signals.

At step S208, each of the module controllers 122 detects the voltage and temperature of each of the battery cells 120. At step S209, each of the module controllers 122 determines that the charging is not permitted, if at least one (1) of the battery cells 120 within the battery module 112, because it has been fully charged, has a voltage not lower than a predetermined voltage, if the monitor wires 123 are broken, or if the voltages of the battery cells 120, because of their failure or the like, have mutual differences not smaller than a predetermined value.

At step S209, if, however, each of the module controllers 122 determines that all the battery cells 120, because they have not been fully charged, have their voltages lower than the predetermined voltage, with the differences between the voltages of the battery cells 120 smaller than the predetermined value, then the process proceeds to step S211 to allow each of the module controllers 122 to transmit to the main controller 134 an information signal indicating that the battery cells 120 have voltages which permit the charging.

At step S212, if each of the module controllers 122 determines that the battery cells 120 have temperatures falling outside a predetermined range to permit charging, like lower temperatures or higher temperatures which can adversely affect the cycle life of each of the battery cells 120, then the process proceeds to step S210. If, however, each of the module controllers 122 determines that the battery cells 120 have temperatures within the predetermined range to permit charging, then the process proceeds to step S213 to allow each of the module controllers 122 to transmit to the main controller 134 an information signal indicating that the battery cells 120 have temperatures which permit the charging. Step S214 follows to turn the FET 129 ON.

On the other hand, the main controller 134 is configured to transmit, at step S206, to the module controllers 122 instruction signals each of which indicates that the charging is permitted, and to wait, at step S215, for reception of information signals from the module controllers 122, wherein each of the information signals indicates that the battery cells 120 have voltages which permit the charging. If the main controller 134 receives the information signals from all of the three (3) module controllers 122, then the process proceeds to step S216. If, however, the main controller 134 does not receive any information signal from at least one of the three (3) module controllers 122, then the process proceeds to step S219.

The main controller 134 is configured to wait, at step S216, for reception of information signals from the module controllers 122, wherein each of the information signals indicates that the battery cells 120 have a temperature which permits the charging. If the main controller 134 receives the information signals from all of the three (3) module controllers 122, then the process proceeds to step S217.

If, however, the main controller 134 does not receive any information signal from at least one of the three (3) module controllers 122, then the process returns to an initial process step in the charge preparation mode at step S201. When the process returns to the initial process step, step S215 has been implemented to determine that the battery cells 120 have voltages which permit the charging. For this reason, in an example in which the battery pack that is hot just after discharging is left in an atmosphere at a room temperature, the process is repeated in a manner that the process returns from step S216 to step S210 and then returns to step S216, until the battery cell temperature is brought into a temperature range to permit charging, and, if the battery cell temperature is brought into the temperature range to permit charging, then the process proceeds to step S217.

At step S217, the main controller 134 detects individual battery module voltages of the three (3) battery modules 112. At step S218, the main controller 134 determines that the charging is not permitted, if at least one of the three (3) battery modules 112 has a module voltage not lower than a predetermined voltage because the battery module 112 has been fully charged, or if the module voltages of the battery modules 112 have mutual differences not smaller than a predetermined value because of failure of the battery modules 112 or the like. Step S219 follows to transmit an instruction signal indicating that the charging is not permitted, from the main controller 134 to each of the module controllers 122. Further, step S220 follows to allow the module controllers 122 to turn the FETs 129 OFF, and the process enters the standby mode at step S001.

At step S218, if, however, it is detected that all the battery modules 112 have module voltages lower than the predetermined voltage and the module voltages of the battery modules 112 have mutual differences smaller than the predetermined value, then the process proceeds to the charge mode at step S301.

In the present embodiment, with the main controller 134 acting as a master controller, the module controller 122 acting as a slave controller, the main controller 134 controls the FET 129 for module charge, via the module controller 122. Therefore, a portion of the main controller 134 which implements step S219 constitutes an example of the “charge control circuitry” set forth in the above-described mode (3).

A hypothetical case is considered where, in the charge preparation mode as shown in FIG. 27, one of the three (3) battery modules 112 is situated such that at least one of its battery cells 120 has an abnormal voltage; where the module controller 122 which corresponds to the one battery module 112 has suffered from a failure and, at step S209, makes a false determination that the battery cell voltage falls within an allowable range for charging; and where the module controller 122, at step S211, transmits to the main controller 134 a false information signal indicating that the battery cell voltage is permitted to be charged.

In this hypothetical case, thereafter, the main controller 134, at step S217, detects the battery module voltage per each battery module 112, which is followed by step S218 to determine that the battery module voltage of the one battery module 112, which includes at least one battery cell 120 having an abnormal voltage, falls outside the allowable range for charging, or otherwise step S218 follows to determine that the one battery module 112 is different in voltage from the remaining battery modules 112, that is, all the battery modules 112 have mutual significant differences, resulting in entry into step S219 and its subsequent steps, in any case.

As a result, the main controller 134, because of its own rejection to enter the charge mode, turns off the SCR of the charge control section 141, and also, the module controller 122, upon reception of an instruction signal indicating that the charging is not permitted, from the main controller 134, turns off the FET 129. The above-described process can provide fault tolerance for a false determination by any one of the battery modules 112.

Another hypothetical case is also considered where the module controller 122, after making the above-described false determination, receives the instruction signal to indicate rejection of charging from the main controller 134; and where the module controller 122 has a cumulative failure and so has failed to turn off the FET 129, even in an attempt to do so, because the FET 129 has been short-circuited. Even in this case, the module controllers 122 which correspond to the remaining normal-operating two (2) battery modules 112, receive the instruction signal to indicate rejection of charging from the main controller 134, and the these normal module controllers 122 turn off their respective FETs 129, resulting in the achievement of the fault tolerance.

Still another hypothetical case is also considered where the main control assembly 114 has suffered from a failure and so has failed to stop charging. Even in this case, the three (3) module controllers 122 detect, through their separate operations, either the states of their respective battery modules 112 being charged, or the states of the digital-communications with the main controller 134, with the common result that the main controller 134, because of its own decision, is able to disable charging.

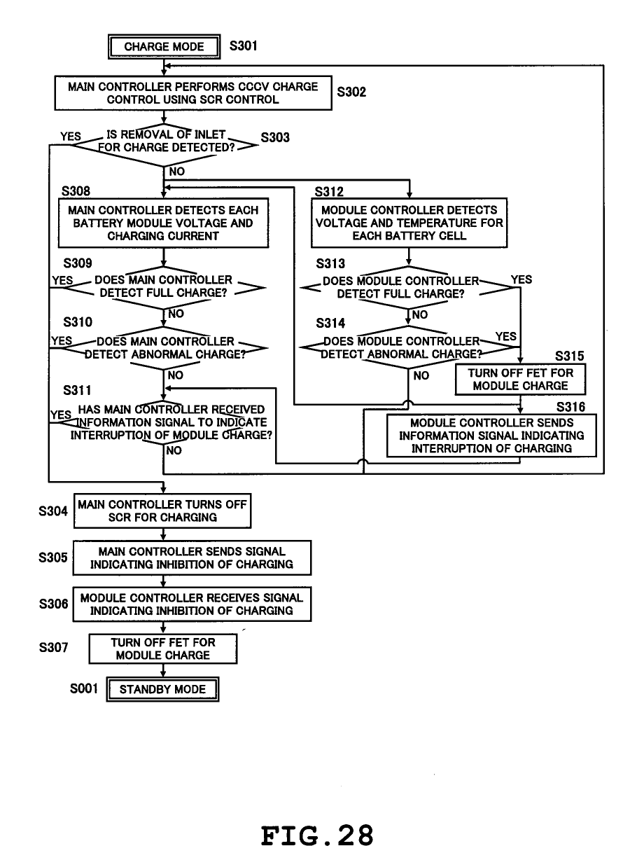

FIG. 28 illustrates in a flowchart, the charge mode of the battery pack 100.

As shown in FIG. 28, at step S317, typical CCCV charge control (Constant-Current, Constant-Voltage method) is performed for the Li-ion battery cells 120. That is, the CCCV charge control is a method for controlling the charging voltage and the charging current such that the charging current does not exceed an upper limit of current, until the Li-ion battery voltage reaches a predetermined voltage, and such that the Li-ion battery voltage, after having reached a predetermined voltage, is maintained at the same voltage.

As shown in FIG. 28, at step S303, if it is detected that the inlet 108 has been removed while being charged, then step S304 is implemented to cause the main controller 134 to turn off the SCR of the charge control section 141, step S305 follows to cause the main controller 134 to transmit to the module controllers 122, an instruction signal indicating that the charging is not permitted, step S306 follows to allow the module controller 122 to receive the instruction signal, and step S307 follows to turn off the FETs 129, resulting in entry into the standby mode at step S001.

On the other hand, at step S303, if the charge is performed without removal of the inlet 108, then the process proceeds to step S308 implemented by the main controller 134 and step S312 implemented by the module controllers 122.

At step S308, the main controller 134 detects the battery module voltage and the charging current of each battery module 112. At step S309, if the main controller 134 determines that each battery module 112 has been fully charged, as a result of detection of a state that the battery module voltage is not lower than a predetermined voltage, or otherwise a state that the charging current is not higher than a predetermined current at a nearby end of the termination of the CCCV charge control (constant-voltage charge control), then the process proceeds to step S304 and its subsequent steps to disable charging.

At step S310, if there is detected at least one of a state that the charging current is over-current, a state that there is no passage of current, a state that a selected one of the charging voltage and the charging current cannot be controlled to reach a target value because of the voltage fluctuations of the commercial power source, or a state that the module voltages of the battery modules 112 have mutual differences not smaller than a predetermined value, then the process proceeds to step S304 and its subsequent steps to disable charging.

At step S311, if the main controller 134 receives an information signal indicating that each module controller 122 has turned off the FET 129, then the process proceeds to step S304 and its subsequent steps to disable charging.

At step S312, each module controller 122 detects the voltage and the temperature of each battery cell 120. At step S313, if each module controller 122 determines that the corresponding battery module 112 has been fully charged, as a result of detection of a state that at least one (1) of the battery cells 120 within each battery module 112 has a voltage higher than a predetermined voltage, then, at step S315, the FET 129 is turned off, and, at step S316, each module controller 122 transmits to the main controller 134, an information signal indicating that the charging is disabled by each battery module 112 on its side.

At step S314, if each module controller 122 detects at least one of a state that the battery cell temperature exceeds an allowable range for charging, a state that a rise in the temperature of the battery cells 120 is not lower than a predetermined value, a state that the voltages of the battery cells 120 have mutual differences not smaller than a predetermined value, or a state that the battery monitor wires 123 have been broken, then the process proceeds to step S315.

At step S315, if the FET 129 is turned off, then, at step S308, the main controller 134 determines again that the voltage is indicating that the charging is disabled by each battery module 112 on its side. Subsequently, at step S316, the information signal indicating that the charging has been disabled is transmitted to the main controller 134, which is followed by step S311 to cause the main controller 134 to make a cumulative determination, and the process proceeds to step S304 and its subsequent steps to disable charging.

It is added that, while FIG. 28 representatively illustrates the control performed in the battery pack 100 according to the first embodiment of the present invention, the same function and results can be provided when a signal indicating that the charging is disabled is transmitted and received between the battery modules 122-3, like in the battery pack 100-3 according to the third embodiment of the present invention, if step S316 is implemented such that the destination of the signal transmitted by the module controller 112-3 is changed from the main controller 134 of the battery pack 100 according to the first embodiment of the present invention, to the battery module controller 112-3 according to the third embodiment of the present invention and, and if the battery module controller 112-3 which has received the signal at step S306, disables the charging.

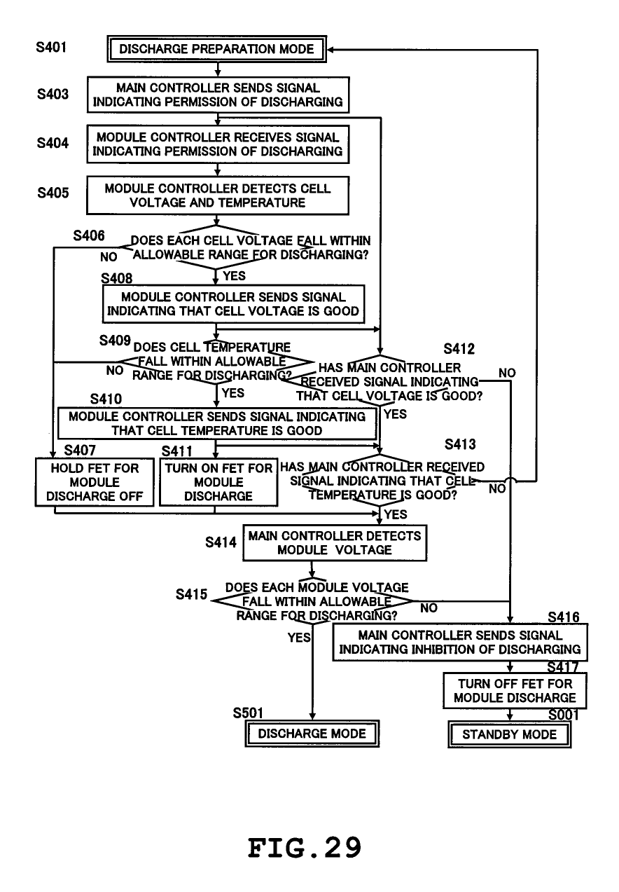

FIG. 29 illustrates in a flowchart, operations in the discharge preparation mode of the battery pack 100.

At step S403, the main controller 134 transmits to the module controllers 122, an instruction signal indicating that the discharging is permitted.

It is added that, when the process proceeds to step S403 while the long-term storage mode at step S101 is being taken, the process does not proceed to any subsequent steps because the main controller 134 is not activated. Accordingly, this prevents the battery cells 120 which have become empty as a result of a long-term storage, from being further overdischarged. At step S404, the module controllers 122 receive the instruction signals. At step S405, each module controller 122 detects the voltage and the temperature of each battery cell 120.

At step S406, each module controller 122 determines that the discharging is not permitted, if at least one of the battery cells 120 has a voltage lower than a predetermined voltage which indicates that the at least one battery cell 120 has been overdischarged, if the voltage monitor wires 123 are broken, or if the voltages of the battery cells 120, because of their failure or the like, have mutual differences not smaller than a predetermined value. Step S407 follows to hold the FETs 130 in an OFF state.

If, however, each module controller 122 determines that every one of all the battery cells 120 within the battery module 112 has a voltage not lower than a predetermined voltage indicating that each battery cell has not been discharged, with the differences between the voltages of the battery cells 120 smaller than a predetermined value, then the process proceeds to step S408 to allow each module controller 122 to transmit to the main controller 134, an information signal indicating that the battery cells 120 have voltages at which the discharging is permitted.

At step S409, if each module controller 122 determines that the battery cells 120 have temperatures outside a predetermined range within which the discharging is permitted, such as a range of lower temperatures or higher temperatures within which the life cycle of each battery cell 120 can be damaged, then the process proceeds to step S407. If, however, each module controller 122 determines that the battery cells 120 have temperatures within the predetermined range to permit discharging, then the process proceeds to step S410 to allow each module controller 122 to transmit to the main controller 134 an information signal indicating that the battery cells 120 have temperatures at which the discharging is permitted, which is followed by step S411 to turn on the FETs 130.

On the other hand, the main controller 134 is configured to transmit, at step S403, to the module controllers 122 instruction signals each of which indicates that the discharging is permitted, and to wait, at step S412, for reception of information signals from the module controllers 122, wherein each of the information signals indicates that the battery cells 120 have voltages at which the discharging is permitted.

If the main controller 134 receives the information signals from all of the three (3) module controllers 122, then the process proceeds to step S413. If, however, the main controller 134 receives no information signal from at least one of the three (3) module controllers 122, then the process proceeds to step S416.

The main controller 134 is configured to wait, at step S413, for reception of information signals from the module controllers 122, wherein each of the information signals indicates that the battery cells have temperatures at which the discharging is permitted. If the main controller 134 receives the information signals from all of the three (3) module controllers 122, then the process proceeds to step S414.

If, however, the main controller 134 receives no information signal from at least one of the three (3) module controllers 122, then the process returns to the initial process step in the discharge preparation mode at step S401. At a time when the process returns to the initial process step, step S412 has been implemented to determine that the battery cells 120 have voltages at which the discharging is permitted. For this reason, in an example in which the battery pack 100 is left outside at high temperatures and therefore becomes too hot to permit the discharging, and then the battery pack 100 is left within a room at room temperatures, the process is repeated in a manner that the process returns from step S413 to step S401 and then returns to step S413, just until the battery cell temperature has fallen down into a temperature range within which the discharging is permitted, and, if the battery cell temperature has fallen down into the temperature range to permit discharging, then the process proceeds to step S414.

At step S414, the main controller 134 detects individual battery module voltages of the three (3) battery modules 112. At step S414, the main controller 134 determines that the discharging is not permitted, if at least one of the battery modules 112 has a module voltage not higher than a predetermined value which indicates that each battery module 112 has been overdischarged, or if the module voltages of the battery modules 112 have mutual differences not smaller than a predetermined value because of failure of the battery modules 112 or the like. Step S416 follows to transmit an instruction signal indicating that the discharging is not permitted, from the main controller 134 to each module controller 122. Further, step S417 follows to allow the module controllers 122 to turn off the FETs 130, and the process enters the standby mode at step S001.

If, however, it is detected that all the battery modules 112 have module voltages not lower than a predetermined value which indicates that each battery module 112 has not been overdischarged and the module voltage of the battery modules 112 have mutual differences smaller than the predetermined value, then the process proceeds to the discharge mode at step S501.

In the present embodiment, with the main controller 134 acting as a master controller, the module controller 122 acting as a slave controller, the main controller 134 controls the FET 130 for module discharge, via the module controller 122. Therefore, a portion of the main controller 134 which implements step S416 constructs an example of the “discharge control circuitry” set forth in the above-described mode (1).

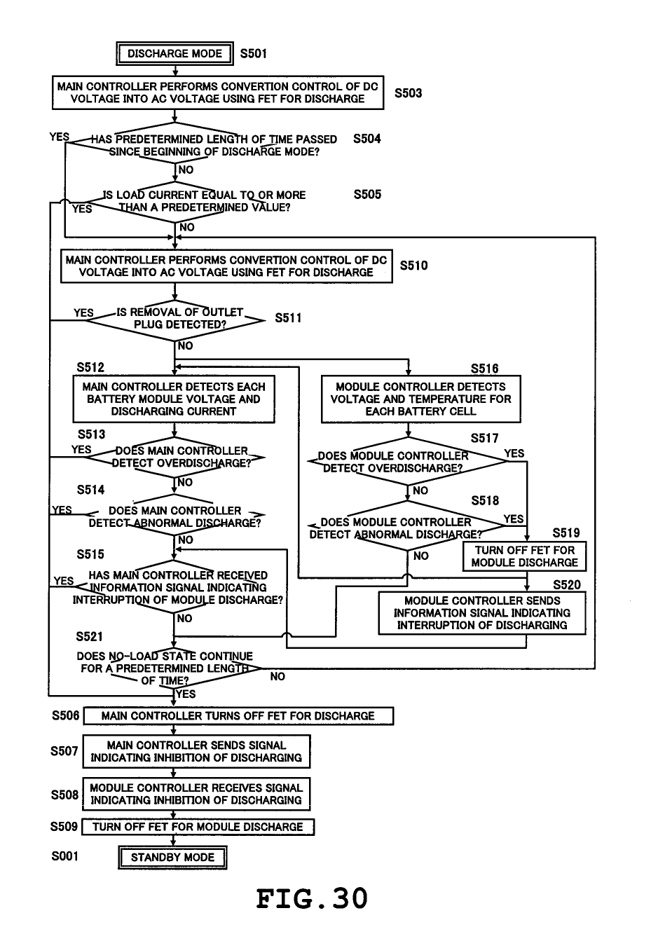

FIG. 30 illustrates in a flowchart, operations in the discharge mode of the battery pack 100.

At step S503, the main controller 134 allows the discharge control section 140 to covert DC voltage into AC voltage which is equivalent to the effective value of the commercial power source. At steps S504 and S505, if a load current which is equal to or more than a predetermined current is detected within a predetermined length of time since the beginning of the discharge mode, then the process proceeds to step S506 and its subsequent steps to disable discharging. For example, for a grinder as an exemplary AC power tool, which has a switch of a toggle type, if the outlet plug is inserted into the battery pack 100 with the switch held ON, the blade is prevented from being unexpectedly activated.

Step S506 and its subsequent steps are process steps to disable the discharging. More specifically, at step S506, the main controller 134 turns off the FETs of the discharge control section 140. At step S507, the main controller 134 transmits to the module controllers 122 instruction signals each of which indicates that discharging is not permitted. At step S507, the main controller 134 transmits to the module controllers 122 instruction signals each of which indicates that discharging is not permitted.

At step S508, the module controllers 122 receive the instruction signals each of which indicates that discharging is not permitted. Step S509 follows to allow the module controllers 122 to turn off the FET 130, and the process enters the standby mode at step S001.

If, at steps S504 and S505, it is determined that flow of current of not less than a predetermined value does not exist within a predetermined time since the beginning of the discharge mode, then the main controller 134, at step S510, allows the discharge control section 140 to convert DC voltage into AC voltage having the same level as the effective value of the commercial power source.

As indicated at step S511, if removal of the outlet plug is detected during discharging, then the process proceeds to step S506 and its subsequent steps to disable discharging. On the other hand, if the discharge is performed without removal of the outlet plug, then the process proceeds to both step S512 which is implemented by the main controller 134, and step S516 which is implemented by the module controllers 122.

At step S512, the main controller 134 detects the battery module voltage and the discharging current of each battery module 112. If, at step S513, the main controller 134 detects one of a state in which the battery module voltage of at least one of the three (3) battery modules 112 has become lower than a predetermined voltage due to overdischarging, and a state in which the module voltages of the battery modules 112 have mutual differences not smaller than a predetermined value, then the process proceeds to step S506 and its subsequent steps to disable discharging.

If, at step S514, the main controller 134 detects that the discharging current has become not lower than a predetermined value due to overload, then the process proceeds to step S506 and its subsequent steps to disable discharging. If, at step S515, the main controller 134 receives an information signal that each module controller 122 has turned off the FETs 130, then the process proceeds to step S506 and its subsequent steps to disable discharging.

If, at step S521, the main controller 134 detects that a non-discharge state with the outlet plug not removed continues for a period not shorter than a predetermined time, for example, one day, then the process proceeds to step S506 and its subsequent steps to disable discharging.

As a result, for example, when the cordless power tool 200 is electrically connected with the battery pack 100, and is left unused for a long time, the battery pack 100 enters the standby mode, to thereby block the discharging path, and reduce a maximum possible voltage impressed to every section within the battery pack 100 to be lower than a voltage worth one battery module 112, which improves the reliability in electrical insulation.

It is added that, in an alternative, the battery module 112 detects the non-use sate described above, and, in the first embodiment of the present invention, by using the first and the third signals both of which are transmitted and received between the main controller 134 and the battery module 112, or, in the third embodiment of the present invention, by using the disabling signal which is transmitted and received between the battery modules 112, output operation of all of the battery modules 112 housed within the battery pack 100 is disabled, with improvement in the reliability in electrical insulation to the same extent.

At step S516, each module controller 122 detects the voltage and the temperature of each battery cell 120. If, at step S517, each module controller 122 detects one of a state in which at least one of the battery cells 120 within each battery module 112 has a voltage lower than a predetermined voltage due to overdischarge, and a state in which the voltage monitor wires 123 are broken, then, at step S519, the FETs 130 are turned off, and, at step S520, each module controller 122 transmits to the main controller 134, an information signal indicating that the discharging is disabled by each battery module 112 on its side.

If, at step S518, each module controller 122 detects at least one of a state in which the battery cell temperature exceeds an allowable range for discharging, a state in which a temperature rise per unit time of the battery cells 120 is not lower than a predetermined value, and a state in which the voltages of the battery cells 120 have mutual differences not smaller than a predetermined value, then the process proceeds to step S519.

After step S519, is executed to turn off the FETs 130, step S512 is repeated to determine whether it is at a voltage at which the discharging is disabled by each battery module 112 on its side, and also step S520 is executed to transmit an information signal indicating interruption of the discharging to the main controller 134, which is followed by step S515 for repeated determination, and the process proceeds to step S506 and its subsequent steps to disable discharging.

It is added that, while FIG. 30 representatively illustrate of the control performed in the battery pack 100 according to the first embodiment of the present invention, the same function and results can be provided when a signal indicating that the discharging is disabled is transmitted and received between the battery modules 112-3, like in the battery pack 100-3 according to the third embodiment of the present invention, if step S520 is implemented such that the destination of the signal transmitted by the module controller 112-3 is changed from the main controller 134 of the battery pack 100 according to the first embodiment of the present invention, to the module controller 112-3 of the battery pack 100-3 according to the third embodiment of the present invention, and, if the module controller 112-3 which has received the signal at step S508, disables the discharging.

In some embodiments described above, a portion of the main controller 134 (illustrated in FIG. 19) which implements step S416 (illustrated in FIG. 29) constructs an example of the “discharge control circuitry” set forth in the above-described mode (1). In addition, a portion of the main controller 134-3 (illustrated in FIG. 34) which implements step S503 (illustrated in FIG. 30) constructs an example of the “discharge control circuitry” set forth in the above-described mode (2), while the module controller 122-3 (illustrated in FIG. 33) constructs an example of the “module control circuitry” set forth in the same mode.

Moreover, a portion of the main controller 134 (illustrated in FIG. 19) which implements step S219 (illustrated in FIG. 27) constructs an example of the “charge control circuitry” set forth in the above-described mode (3). Furthermore, a portion of the main controller 134-3 (illustrated in FIG. 34) which implements step S304 (illustrated in FIG. 28) constructs an example of the “charge control circuitry” set forth in the above-described mode (4), while the module controller 122-3 (illustrated in FIG. 33) constructs an example of the “module control circuitry” set forth in the same mode.

Still further, the load control section 401 (illustrated in FIG. 36) included in the electric device constructs an example of the “discharge control circuitry” set forth in the above-described mode (11). Additionally, the charge control section 413 (illustrated in FIG. 37) included in the charger 410 constructs an example of the “charge control circuitry” set forth in the above-described mode (12).

Reference throughout the specification to “one embodiment” or “an embodiment” means that a particular feature, structure, or characteristic described in connection with the embodiment is included in at least one embodiment of the present invention.

Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A battery pack usable as a power source for an electric device, comprising:
a battery cell group of a plurality of battery cells which are interconnected in series;
discharge control circuitry for performing discharge control for the battery cell group;
a discharge output terminal through which a discharge output of the battery cell group is supplied to the electric device; and
a casing within which the battery cell group, the discharge control circuitry and the discharge output terminal are housed,
wherein the battery cell group cooperates with an input/output terminal electrically connected with the battery cell group to constitute a battery module,
the battery module is serially connected with another or other battery modules to constitute a battery module group, and
the battery module group is electrically connected with the discharge control circuitry,
the battery pack further comprising:
a first detector detecting at least one of a voltage, a temperature and a current, of at least one of the battery cells in the battery cell group; and
a first selector configured to select one of a mode in which output of a voltage through the input/output terminal is enabled, and a mode in which the output of a voltage is disabled,
wherein the discharge control circuitry transmits to the first selector a first signal indicating that output of a voltage to the discharge output terminal is disabled, when the discharge control circuitry attempts to disable the output of a voltage to the discharge output terminal, based on a detection result of the first detector, and
the first selector, based on the first signal received from the discharge control circuitry, disables the output of a voltage through the input/output terminal.

2. The battery pack according to claim 1, further comprising:
circuitry for measuring a length of a non-use time during which the battery pack is not used for electrical purposes; and
circuitry for disabling a current flow through the input-output terminal, if the measured non-use time exceeds a predetermined length of time.

3. The battery pack according to claim 1, further comprising:
circuitry for determining whether an outlet plug of the electric device has been connected with the discharge output terminal; and
circuitry for disabling output of at least one of the input/output terminal and the discharge output terminal, if the outlet plug of the electric device has not been connected with the discharge output terminal, or if the battery pack has been unused for a predetermined length of time or more, with the outlet plug of the electric device connected with the discharge output terminal.

4. The battery pack according to claim 1, wherein each of the serially-interconnected battery modules generates a voltage not exceeding 42 volts, at the input/output terminal.

5. The battery pack according to claim 1, wherein the battery pack generates a voltage not lower than 84 volts, at the discharge output terminal.

6. The battery pack according to claim 1, wherein each of the serially-interconnected battery modules generates a nominal voltage not exceeding 36 volts, at the input/output terminal.

7. The battery pack according to claim 1, wherein the battery pack generates a nominal voltage not lower than 72 volts, at the discharge output terminal.
